(19) United States
(12) Patent Application Publication
(10) Pub. No.: US 2026/0087887 A1
(43) Pub. Date: Mar. 26, 2026

(54) ELECTRONIC GAMING SYSTEMS INCLUDING INTERACTIVE PROGRESSIVE PICK BONUS GAMES, PERSISTENT BONUS GAME SYMBOLS, AND CUMULATIVE BONUS WHEEL GAMES

(71) Applicant: Aristocrat Technologies, Inc., Las Vegas, NV (US)

(72) Inventors: Jennifer Mizzi, Ewa Beach, HI (US); Rogelio Decasa, JR., Renton, WA (US); Nathan Warms, Austin, TX (US); Nicholas Farina, Granger, IN (US); Kelly Lockheed, Elkridge, MD (US); Zachary Smith, Austin, TX (US); Deanna Hickox, Georgetown, TX (US)

(21) Appl. No.: 18/897,775

(22) Filed: Sep. 26, 2024

(51) Int. Cl. G07F 17/32

(52) U.S. Cl. CPC G07F 17/3267; G07F 17/3209; G07F 17/3213; G07F 17/3258; G07F 17/3262

(57) ABSTRACT

An electronic gaming system includes at least one memory for storing instructions, and a game controller including a processor(s). When the instructions are executed by the processor(s), the processor(s) is configured to determine that a first outcome of a base reel game triggers an interactive pick bonus game, and cause to be displayed a first group of pick bonus game symbols. The processor(s) is also configured to cause to be displayed on the touch enabled display device a credit value or action feature associated with a selected pick bonus game symbol(s) of the first group of pick bonus game symbols, and re-display the base reel game. Additionally, the processor(s) is configured to re-display the interactive pick bonus game, the re-displayed interactive pick bonus game persisting to display the credit value or the bonus feature associated with the selected pick bonus game symbol(s) for the first group.

### TECHNICAL FIELD

The field of disclosure relates generally to electronic gaming, and more specifically, to electronic gaming systems, programs, and methods that include interactive progressive pick bonus games, persistent bonus game symbols, and cumulative bonus wheel games.

### BACKGROUND

Electronic gaming machines (“S&W AR!GMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Notably, some games may include an element of skill on the part of the player and are therefore not entirely random.

### BRIEF DESCRIPTION

In one aspect, an electronic gaming system includes at least one memory for storing instructions, and a game controller in communication with the at least one memory. The game controller includes at least one processor, wherein when the instructions are executed by the at least one processor, the at least one processor is configured to: cause to be displayed on a touch enabled display device a base reel game including a plurality of reels; determine that a first outcome of the base reel game triggers an interactive pick bonus game; cause to be displayed on the touch enabled display device a first group of pick bonus game symbols, each of the pick bonus game symbols associated with a credit value or an action feature; in response to at least one pick bonus game symbol of the first group of pick bonus game symbols being selected via the touch enabled display device, cause to be displayed on the touch enabled display device the credit value or the action feature associated with the at least one selected pick bonus game symbol of the first group; cause to be re-displayed on the touch enabled display device the base reel game; and in response to determining that a subsequent outcome of the re-displayed base reel game triggers the interactive pick bonus game, cause to be re-displayed on the touch enabled display the interactive pick bonus game, the re-displayed interactive pick bonus game persisting to display the credit value or the bonus feature associated with the at least one selected pick bonus game symbol for the first group.

In another aspect, a method of electronic gaming implemented on an electronic gaming machine includes: causing to be displayed on a touch enabled display device a base reel game including a plurality of reels; determining that a first outcome of the base reel game triggers an interactive pick bonus game; causing to be displayed on the touch enabled display device a first group of pick bonus game symbols, each of the pick bonus game symbols associated with a credit value or an action feature; in response to at least one pick bonus game symbol of the first group of pick bonus game symbols being selected via the touch enabled display device, causing to be displayed on the touch enabled display device the credit value or the action feature associated with the at least one selected pick bonus game symbol of the first group; causing to be re-displayed on the touch enabled display device the base reel game; and in response to determining that a subsequent outcome of the re-displayed base reel game triggers the interactive pick bonus game, causing to be re-displayed on the touch enabled display the interactive pick bonus game, the re-displayed interactive pick bonus game persisting to display the credit value or the bonus feature associated with the at least one selected pick bonus game symbol for the first group.

In an additional aspect, a non-transitory computer-readable storage medium with instructions stored thereon is provided. The instructions, in response to execution by at least one processor, cause the at least one processor to: cause to be displayed on a touch enabled display device a base reel game including a plurality of reels; determine that a first outcome of the base reel game triggers an interactive pick bonus game; cause to be displayed on the touch enabled display device a first group of pick bonus game symbols, each of the pick bonus game symbols associated with a credit value or an action feature; in response to at least one pick bonus game symbol of the first group of pick bonus game symbols being selected via the touch enabled display device, cause to be displayed on the touch enabled display device the credit value or the action feature associated with the at least one selected pick bonus game symbol of the first group; cause to be re-displayed on the touch enabled display device the base reel game; and in response to determining that a subsequent outcome of the re-displayed base reel game triggers the interactive pick bonus game, cause to be re-displayed on the touch enabled display the interactive pick bonus game, the re-displayed interactive pick bonus game persisting to display the credit value or the bonus feature associated with the at least one selected pick bonus game symbol for the first group.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIGS. 4A and 4B are example user interfaces or screenshots of a sequence of a base reel game for an example electronic game in accordance with the present disclosure.

FIG. 4C is an example user interface or screenshot of a display of interactive pick bonus game symbols associated with a graphical icon for an example electronic game in accordance with the present disclosure.

FIG. 4D is an example user interface or screenshot of a base reel game outcome of the base reel game triggering an interactive pick bonus game for an example electronic game in accordance with the present disclosure.

FIG. 5 is an example user interface or screenshot of the start of an interactive pick bonus game for an example electronic game in accordance with the present disclosure.

FIGS. 6A-6H are example user interfaces or screenshots of a sequence of a triggered interactive pick bonus game for an example electronic game, in accordance with the present disclosure.

FIGS. 7A-7K are additional examples of user interfaces or screenshots of a sequence of the interactive pick bonus game for an example electronic game, in accordance with the present disclosure.

FIG. 7L is an example user interface or screenshot of a triggered hold-and-spin bonus game of an example electronic game, in accordance with the present disclosure.

FIGS. 8A-8D are examples of user interfaces or screenshots of a sequence of the interactive pick bonus game triggering a bonus wheel game for an example electronic game, in accordance with the present disclosure.

FIGS. 8E-8G are example user interfaces or screenshots of a sequence of a triggered bonus wheel game for an example electronic game, in accordance with the present disclosure.

FIGS. 9A-9C are example user interfaces or screenshots of a sequence of a triggered distinct pick bonus game for the example electronic game, in accordance with the present disclosure.

FIGS. 10A-10G are example tables displaying various scripts of the interactive pick bonus game and the bonus wheel game, in accordance with the present disclosure.

### DETAILED DESCRIPTION

In some known electronic gaming systems, awards and/or outcomes of a primary game may be presented to a player as awards and/or outcomes of a secondary game. For example, an electronic gaming device may present a game outcome as a reel game (e.g., a slot game) simulation. For example, an award value associated with a game outcome may be presented in the simulated reel game outcome as a symbol combination and/or one or more special symbols that correspond to the same award value. In some known games, the award value of the game outcome may be partitioned or distributed across a base reel game outcome and one or more bonus game outcomes (e.g., outcomes of one or more free reel spins, wheel spins, or interactive symbol picks). For example, an award value associated with one or more winning bingo patterns may be presented as being awarded in a base reel game outcome and one or more bonus game outcomes. While some variations exist for presenting the game outcomes across the base reel game outcome and/or the one or more bonus game outcomes exist, the variability and flexibility in presenting these outcomes remain limited. A need exists to address these limitations, while also improving on machine performance, memory storage and the overall functioning of the networked system controlling the gaming devices.

Embodiments of the present disclosure provide systems, program products, and methods for displaying base reel game outcomes that may include a triggering of one or more bonus or auxiliary games, or alternatively displaying bonus games to the player. The bonus games described herein include interactive pick bonus games, a hold-and-spin game, and a bonus wheel game, respectively. The bonus games provide players with a fast-paced animation and the displaying of (potentially) multiple awards or credit values. Additionally, interactive bonus games allow the player to interact with the gaming machine to attempt to win additional awards and credit values during the game. Furthermore, each bonus game can include the ability for the player to play both the bonus game, as well as be presented bonus game features—each awarding additional credit values. Additionally with respect to the interactive pick bonus game, credit values (e.g., cash-on-reel values) and/or action features (e.g., additional picks, hold-and-spin game trigger features, jackpot features) revealed during the game can be persistent and/or be continuously displayed during subsequent instances of the interactive pick bonus game. Furthermore, and with respect to a distinct or end pick bonus game, the player can control the distinct group of symbols in which they are initially presented during subsequent plays of the interactive pick bonus game. The persistence of the credit values and/or action features that potentially carry over through multiple interactive pick bonus games, as well as providing the player the ability to select a starting group of symbols for subsequent pick bonus games during the end pick bonus game, provide an improved electronic game by increasing the variability and flexibility in presenting winning outcomes of the bonus game (e.g., winning symbol combinations and/or special symbols) to the player while maintaining a level or reducing the level of memory and/or computational resources needed to provide these enhancements.

The persistency of credit values and/or action features through the interactive pick bonus game may include, for example, continuously displaying a revealed credit value or jackpot features during the interactive pick bonus game. The persistent credit values and/or action features that remain displayed during subsequent gameplays of the interactive pick bonus game potentially increase the variability of the game including the various bonus games, as well as improve control and assurance of RTP during the gameplay. Additionally, and to improve technical issues commonly experienced during game play, persistence in the credit values and/or action features over multiple displays of the interactive pick bonus game can also reduce the amount of memory required by the gameplay and/or reduce the computational resources needed to operate the game.

Similarly, the ability for the player to determine, define, and/or select the group of interactive pick bonus game symbols for subsequent plays of the interactive pick bonus game during an end pick bonus game also can potentially increase the credit values a player can win, while increasing the variability of the game. The selection of the group of interactive pick bonus game symbols for subsequent plays of the interactive pick bonus game in turn can also improve control and assurance of RTP during the gameplay. Furthermore, selection of the group of interactive pick bonus game symbols during the end pick bonus game can reduce the computational resources needed to operate the game and/or reduce the amount of memory required by the gameplay.

The example systems, program products, and methods of the present disclosure represent a technical improvement in the field of electronic gaming. Technical improvements represented by the present disclosure include: (i) presenting Class II and Class III game outcomes as one or more outcomes of a bonus game and/or bonus features; (ii) providing credit values and/or action features to persist and/or be continuously displayed and in turn awarded during interactive pick bonus games; (iii) utilizing multiple bonus games to provide additional gameplay features/winning opportunities during gameplay; (iv) increasing the flexibility and variability in presenting award values and/or action features of a game outcome as one or more bonus game outcomes; (v) providing players the opportunity to actively participate during the bonus games; (vi) displaying immediate bonus game feedback to a player; (vii) maintaining/reducing the amount of memory needed to carry out the improved variability of the gameplay as a result of persistent credit values/action features and/or selecting the group of interactive pick bonus game symbols for subsequent plays of the interactive pick bonus game; (viii) reducing the computational resources needed as a result of (a) the persistent credit values and/or action features that remain displayed during interactive pick bonus games, and (b) defining the group of interactive pick bonus game symbols for subsequent plays of the interactive pick bonus game; and/or (ix) improved control and assurance of RTP by enabling control of the credit awards through the persistent credit values/action features in the interactive pick bonus games and/or defining the group of interactive pick bonus game symbols for subsequent plays of the interactive pick bonus game. Additional and/or alternative technical improvements may exist.

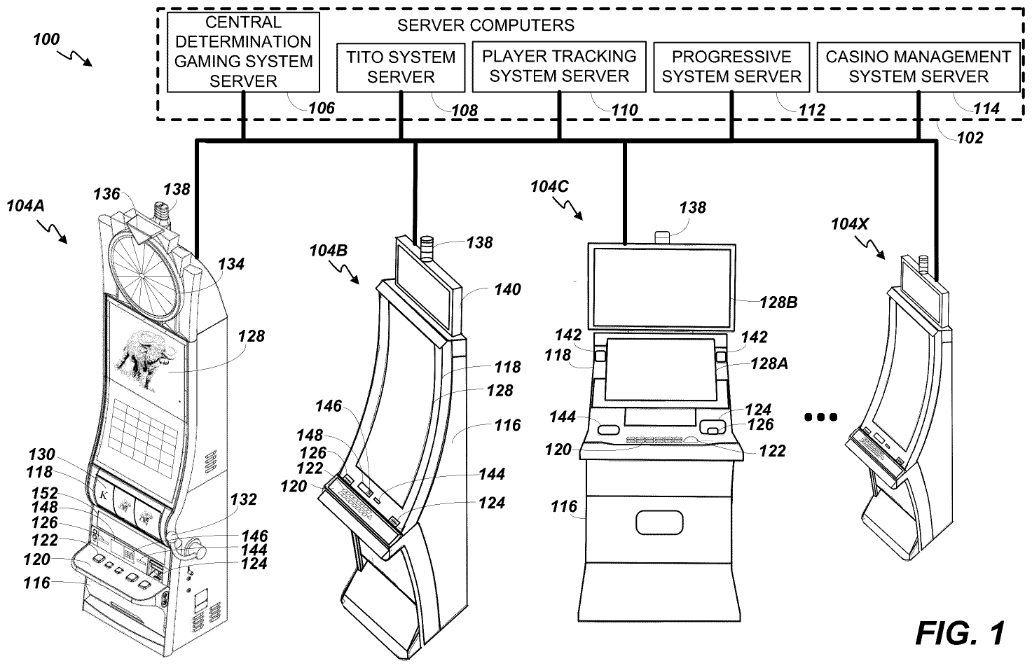

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

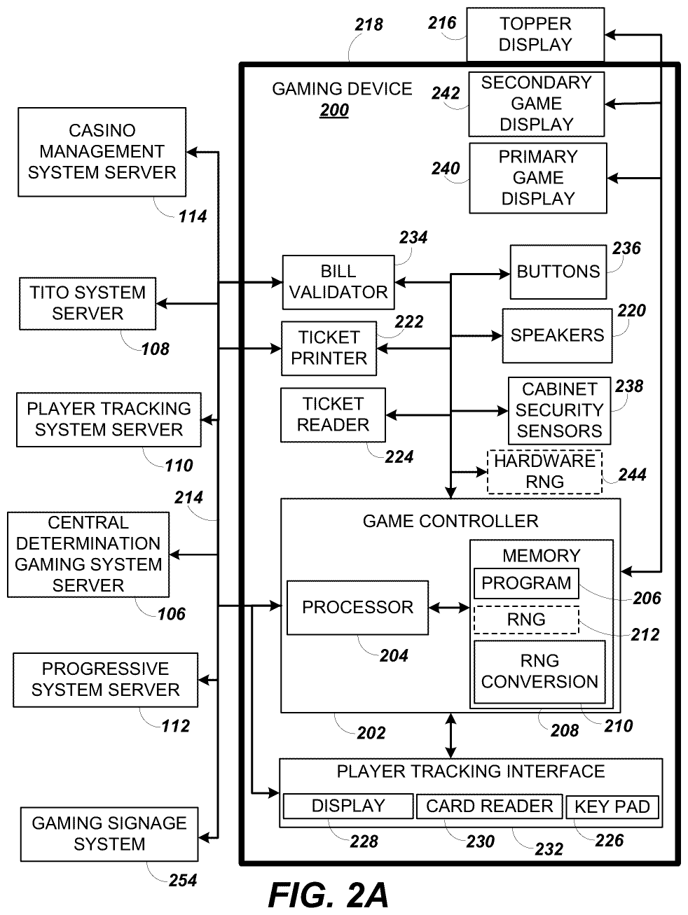

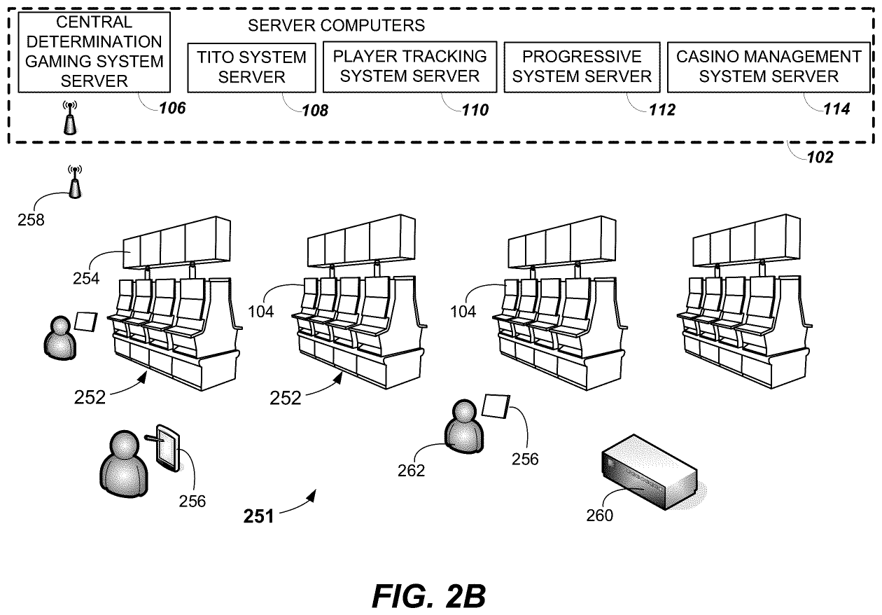

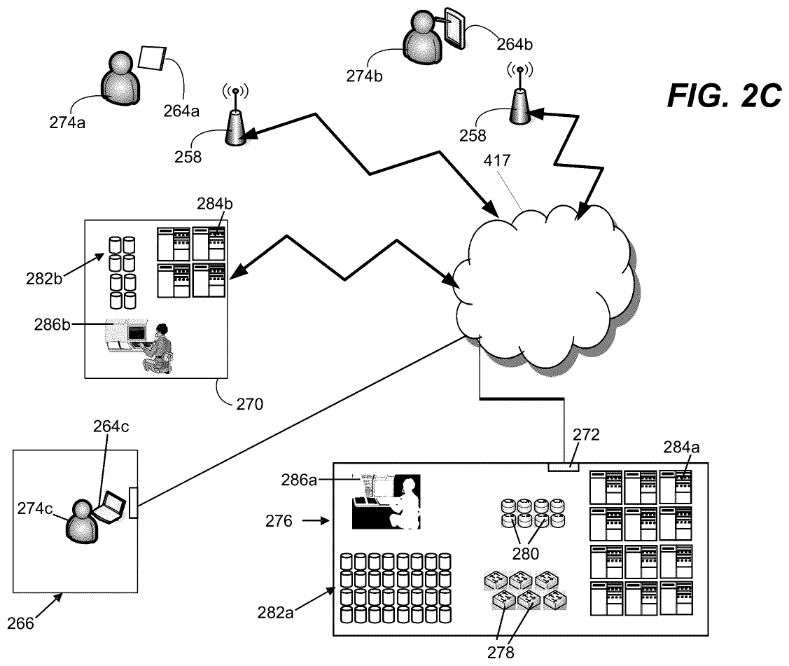

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play, or any other information or media desired by the game designer or operator. In some implementations, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2A also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random-access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more Uis, the game outcome on one or more of the primary game displays 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding number of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

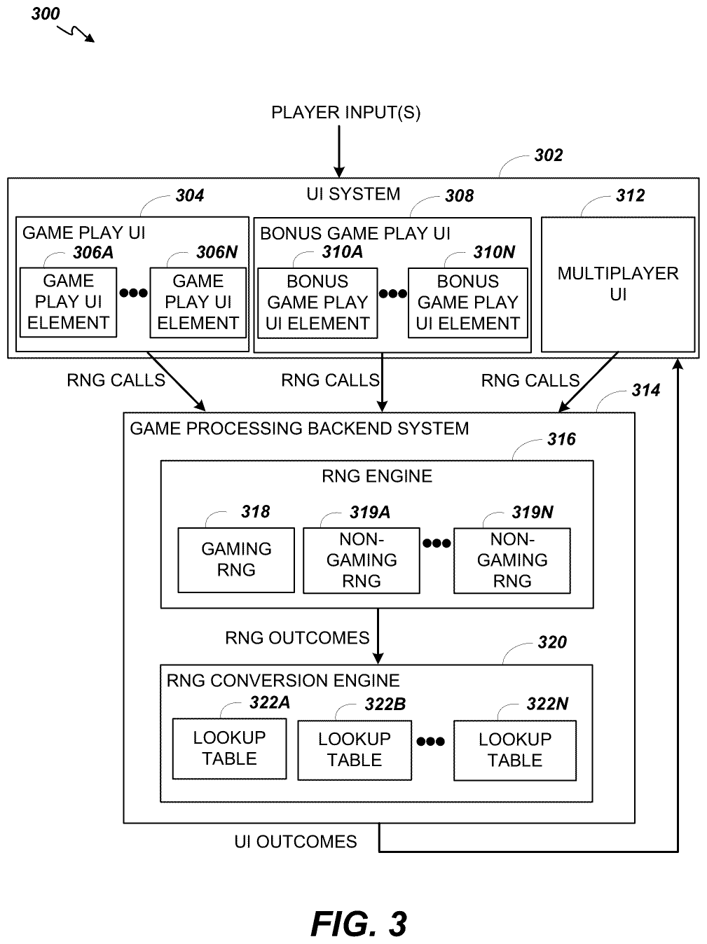

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more Uis that a player can interact with. The UI system 302 could include one or more game play Uis 304, one or more bonus game play Uis 308, and one or more multiplayer Uis 312, where each UI type includes one or more mechanical Uis and/or graphical Uis (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

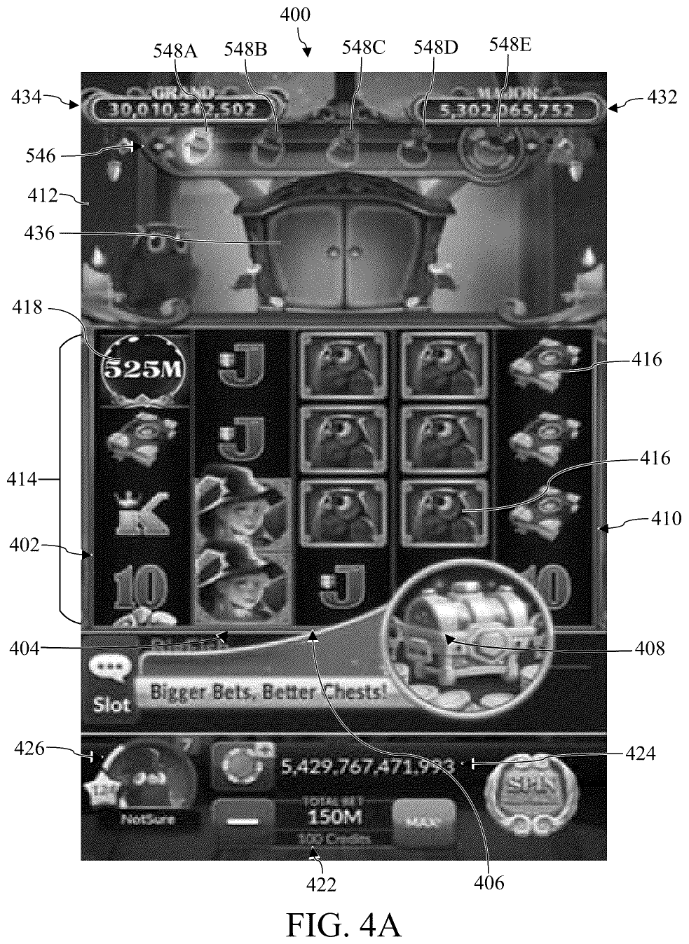

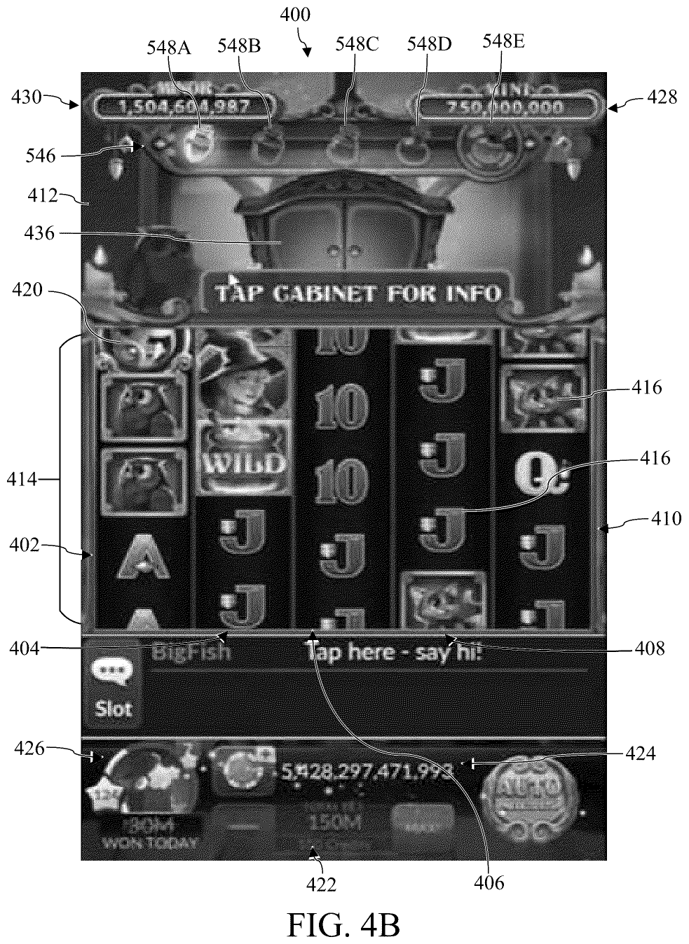

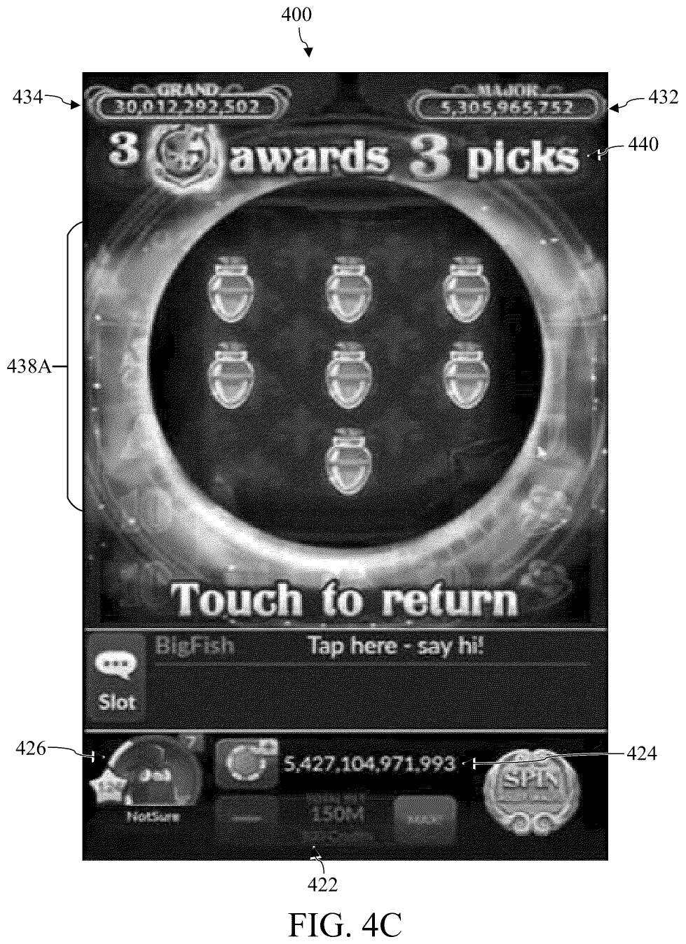

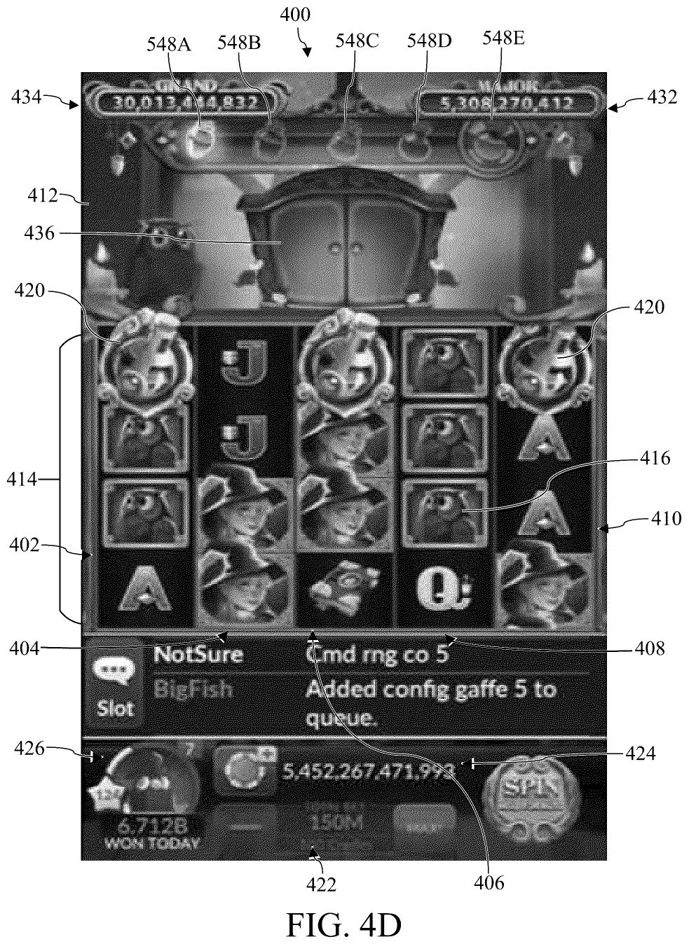

FIGS. 4A and 4B are example user interfaces or screenshots of an example base reel game 400 played on a gaming device (e.g., gaming devices 104A-104X in FIG. 1, and/or gaming device 200 and/or mobile gaming device 256 in FIG. 2B). Specifically, FIG. 4A shows a base reel game 400, in which a base reel game outcome is displayed that corresponds to (e.g., presents, represents, and/or is determined from) an output of the gaming device, while FIG. 4B shows a base reel game 400 mid-spin and/or prior to displaying a base reel game outcome. The output may be a primary game outcome determined in response to a wager received from a player. In example implementations, the primary game outcome is a Class II (e.g., bingo) game outcome or a Class III or Las-Vegas style game outcome. In various implementations, the base reel game 400 may be implemented to present an outcome of any suitable game of chance. Specific details of the type of primary or base reel game outcomes presented using the base reel game 400 are not central to an understanding of the present disclosure. However, additional detail related to at least one implementation (e.g., an implementation employing the base reel game 400 to present a primary bingo-based or Class II game outcome) may be obtained with reference to U.S. Published Patent Application No. 2012/0270638, filed Apr. 20, 2011, and entitled GAMING MACHINE WITH FREE PLAY BONUS MODE PRESENTING ONLY WINNING OUTCOMES, the disclosure of which is hereby incorporated by reference herein in its entirety.

The base reel game 400 may be initiated on a gaming device 104A-104X, 200 and/or mobile gaming device 256. For example, a player may fund the base reel game 400 via bill validator 234 and/or ticket reader 224. Once funded, the base reel game 400, which includes a first plurality of reels 402, 404, 406, 408, and/or 410, each including a plurality of game symbols 414 that appear on a display device 412. The first plurality of reels 402-410 may be physical reels and/or virtual reels. As used herein, physical reels are mechanical in nature and may be physically rotated during gameplay. In contrast, virtual reels are rendered or visually created by game controller 202 on a display, such as primary game display 240, and are merely animated to give the appearance of being spun. The first plurality of reels 402-410 of the example base reel game 400 includes five reels. In other examples, the number of reels may range from one reel to five or more reels in number. The base reel game 400 may be played on display device 412. However, in other implementations, the base reel game 400 may be played on several displays including display device 412 and one or more additional or

### Auxiliary Displays.

The base reel game 400 may be played on multiple displays, such as the primary display device 412 and a secondary display. However, in other implementations, the base reel game 400 may be played on a single display and/or on greater than two displays. Additionally, display device 412 can be configured as a touch enabled display device to allow the player to engage with and/or play base reel game 400 and/or interactive pick bonus game, when displayed on touch enabled display device 412. For example, where the gaming device is formed as mobile gaming device 256 (see, FIG. 2B), display device 412 includes mobile gaming device's 256 touch screen or screens. As discussed herein, the user or player may touch display device 412 to operate and/or interact with base reel game 400 and/or interactive pick bonus game during game play. Touch enabled display device 412 (and/or controller 202/processor 204) may detect, recognize, and/or identify the player's touch, and determine the player's various interactions and/or selections during gameplay.

In the example shown in FIGS. 4A and 4B, the base reel game 400 includes a first reel matrix on the primary display device 412. The first reel matrix includes a plurality of symbol arrangements or positions arranged in a plurality of rows and a plurality of columns. The first reel matrix may also therefore be referred to as a “matrix of symbol positions” or “matrix of symbol arrangements.” While, in the example shown in FIGS. 4A and 4B, the first reel matrix is displayed on the primary display device 412, the first reel matrix may appear in other locations on an EGM 104A-104X and/or on other displays, such as, for example, the secondary display, a display of button deck 120, and the like. In the example embodiment shown in FIGS. 4A and 4B, the plurality of reels 402-410 form five distinct reels and/or five columns. Each reel 402-410 also includes a number of rows as well. In the exemplary embodiment, reels 402-410 have four (4) rows. As a result, the plurality of reels 402-410 for base reel game 400 include a 4×4×4×4×4 arrangement, as depicted on display device 412, and include twenty (20) game symbol positions.

In other implementations, the plurality of reels 402-410 may be any size/uniformity/arrangement (e.g., 2×2, 3×3, 4×4, 10×10, etc.), and a number of game symbol positions for the plurality of reels 402-410 may vary depending upon a number of rows and columns of the plurality of reels 402-410. In some implementations, the plurality of reels 402-410 may be replaced by one or more mechanical reels, and the implementations described herein work equally well with mechanical reels as with the virtual plurality of reels 402-410, as shown in FIGS. 4A and 4B. Each row of the plurality of reels 402-410 may be designated by a row number (e.g., “1,” “2,” “3,” etc.). Each column of the plurality of reels 402-410 may be designated by a column letter (e.g., “A,” “B,” “C,” “D,” “E,” etc.). Each game symbol position of the plurality of reels 402-410 may therefore be designated by a symbol position identifier comprising a row number (e.g., “1,” “2,” “3,” etc.) and a column letter (e.g., “A,” “B,” “C,” “D,” “E,” etc.). For example, the upper-right-most game symbol position, occurring at the intersection of row 1 and column E, may be designated by the game symbol position identifier “1E.” In another example, the bottom most game symbol position for reel 406, occurring at the intersection of row 4 and column C, may be designated by the game symbol position identifier “4C.”

As described herein, during play of the base reel game 400, game symbols 414 may be selected (e.g., such as from the plurality of reels 402-410) and displayed in the game symbol positions of each column and row of the plurality of reels 402-410. Although not central to an understanding of the present disclosure, each of the plurality of reels 402-410 may include a plurality of game symbols 414 arranged in a vertical column. A number of game symbols 414 of each reel 402-410, corresponding to the number of rows of the plurality of reels 402-410, is displayed in a column of game symbol positions within the plurality of reels 402-410 during play of the base reel game 400. To display symbols from a reel within the plurality of reels 402-410, processor 204 may simulate rotation or spinning of one or more of the plurality of reels 402-410 within a respective column of the plurality of reels 402-410. Here again, however, mechanical reels having physical reel strips may be used as well. When a respective reel is simulated to halt or stop within an associated column, one or more game symbols 414 may be displayed from the reel 402-410 in the game symbol positions of the column. The game symbols 414 displayed after spinning and stopping each reel strip in a respective column of the plurality of reels 402-410 may be referred to herein as a “reel outcome” or a “base reel game outcome” or a “base game outcome.” More broadly, an “outcome” of a reel game, such as a base reel game (e.g., the base reel game 400) refers to the game symbols 414 displayed in the plurality of reels 402-410 after reel strips are spun and stopped. Thus, a rotation and stopping of a plurality of reel strips (also referred to herein as a “spin and stop sequence”) may be simulated by processor 204 within the columns of the plurality of reels 402-410 to cause a reel outcome, including a plurality of game symbols 414, to be displayed from the plurality of reel strips within the columns of the plurality of reels 402-410.

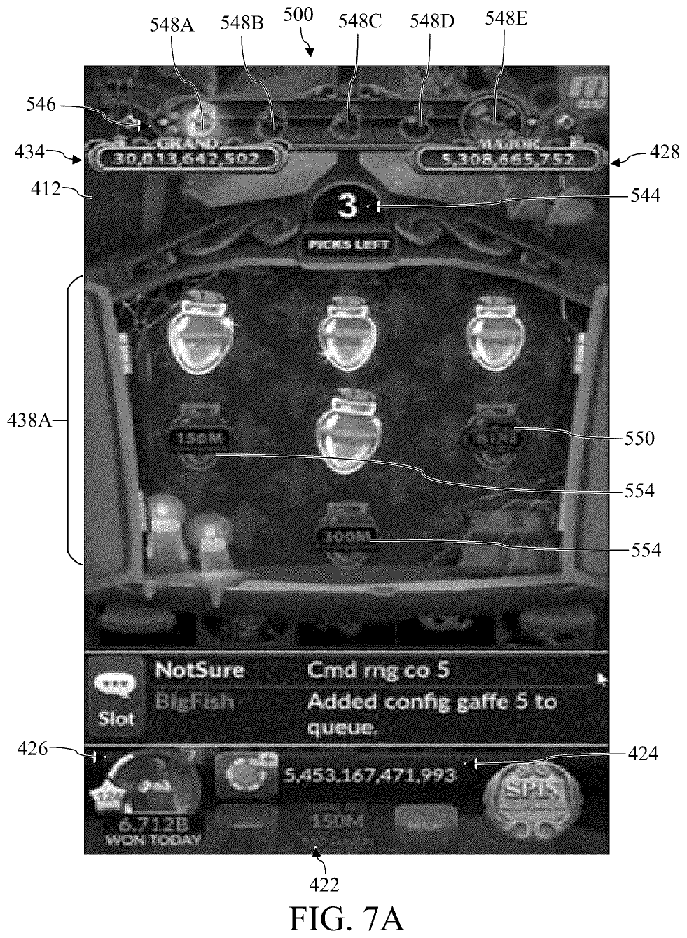

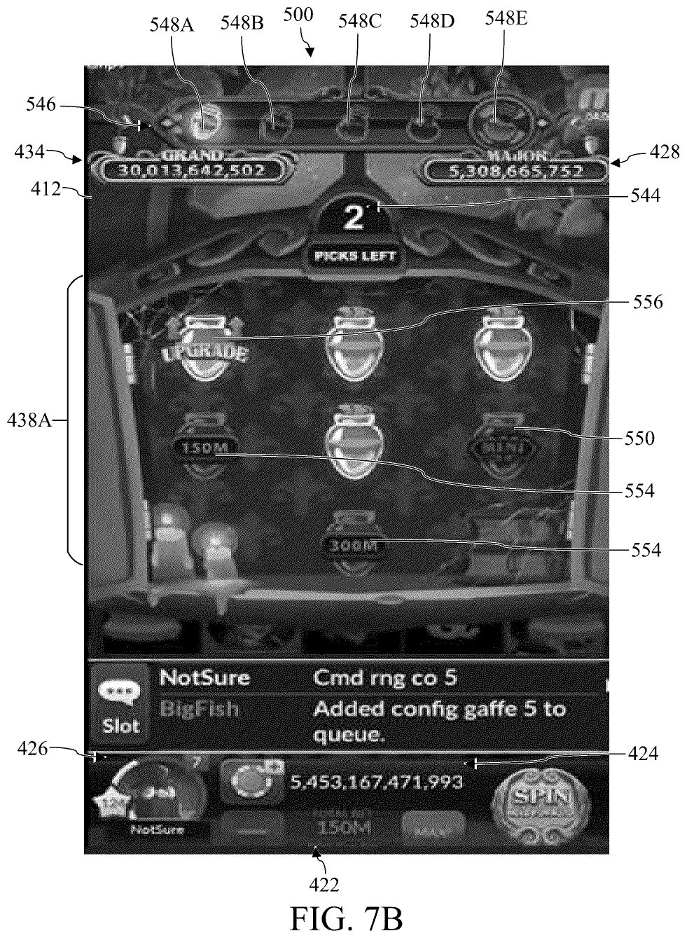

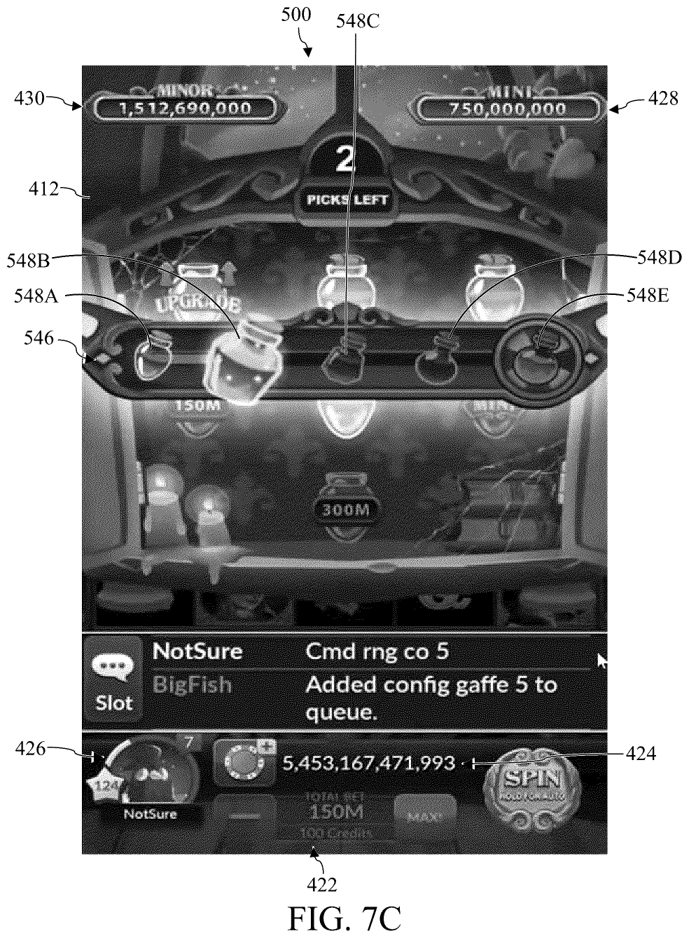

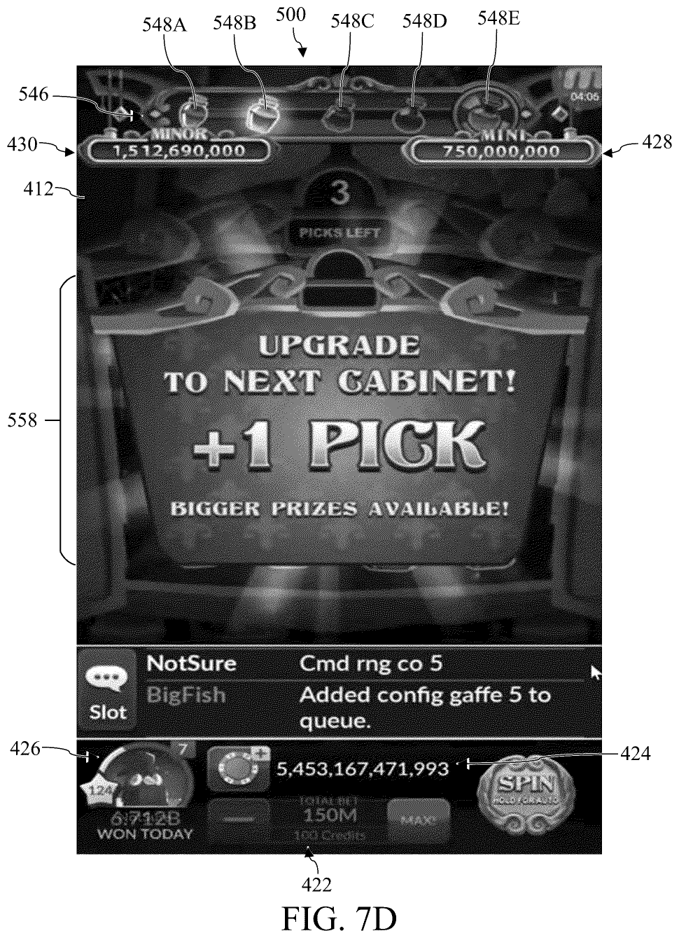

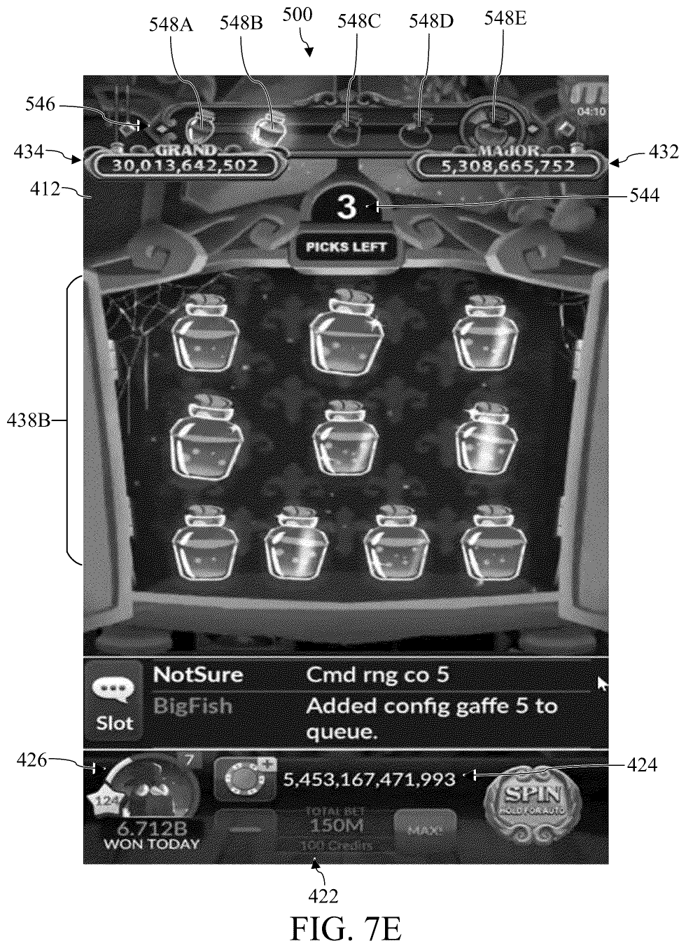

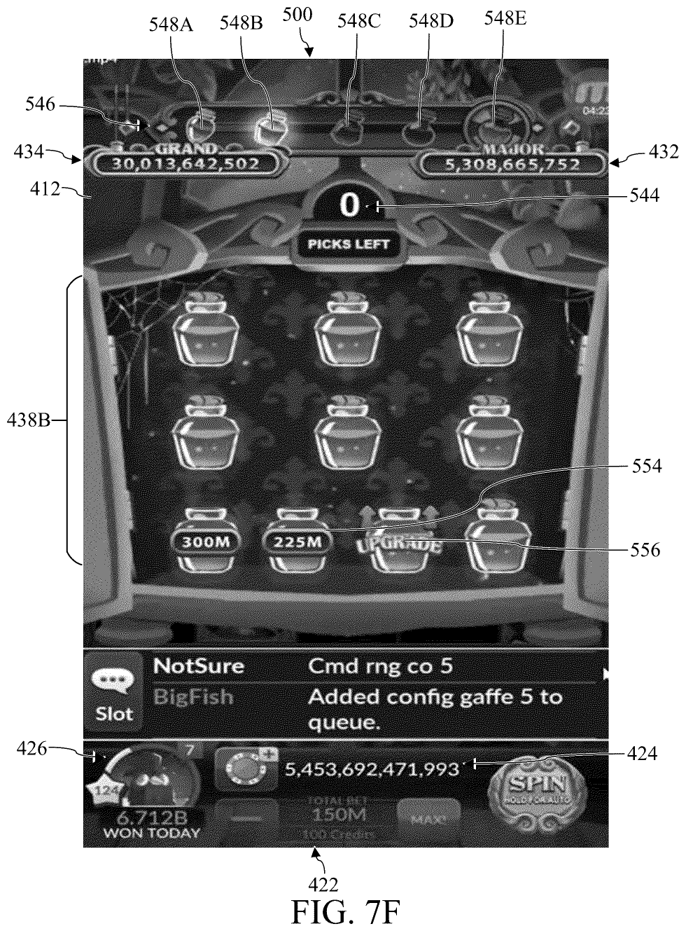

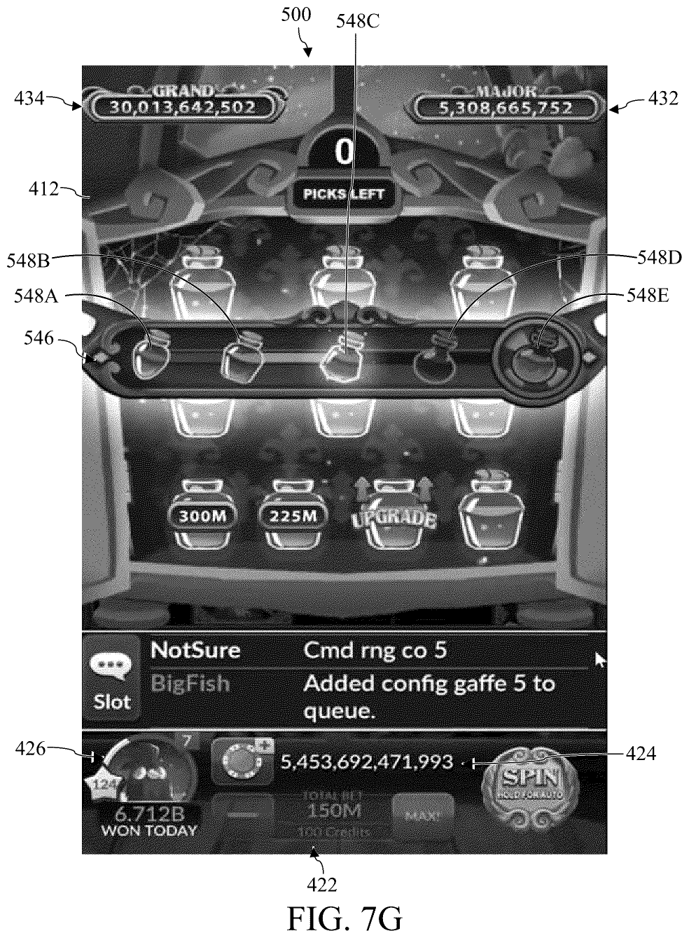

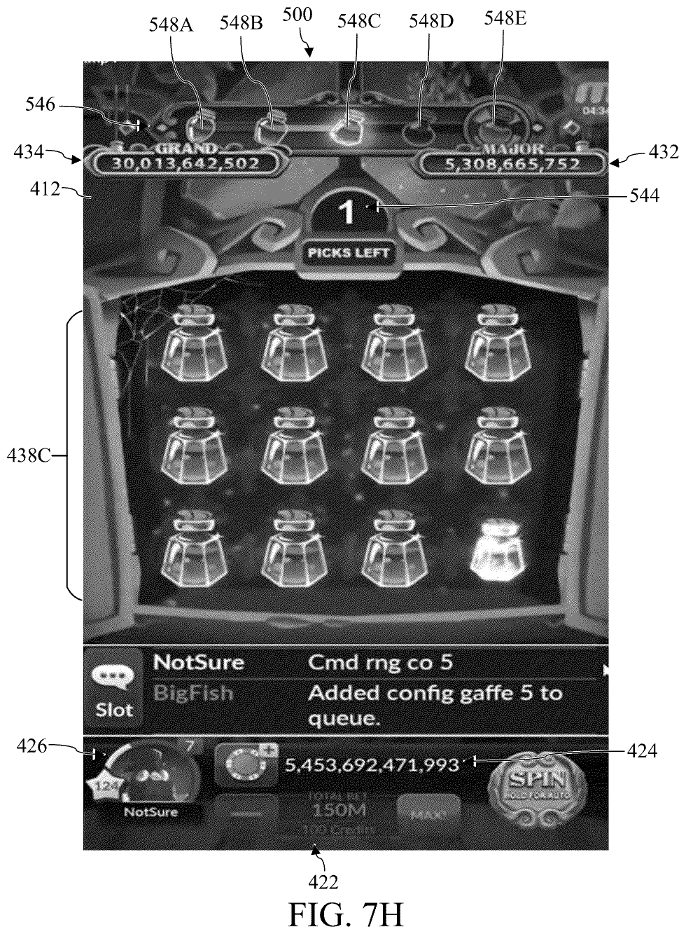

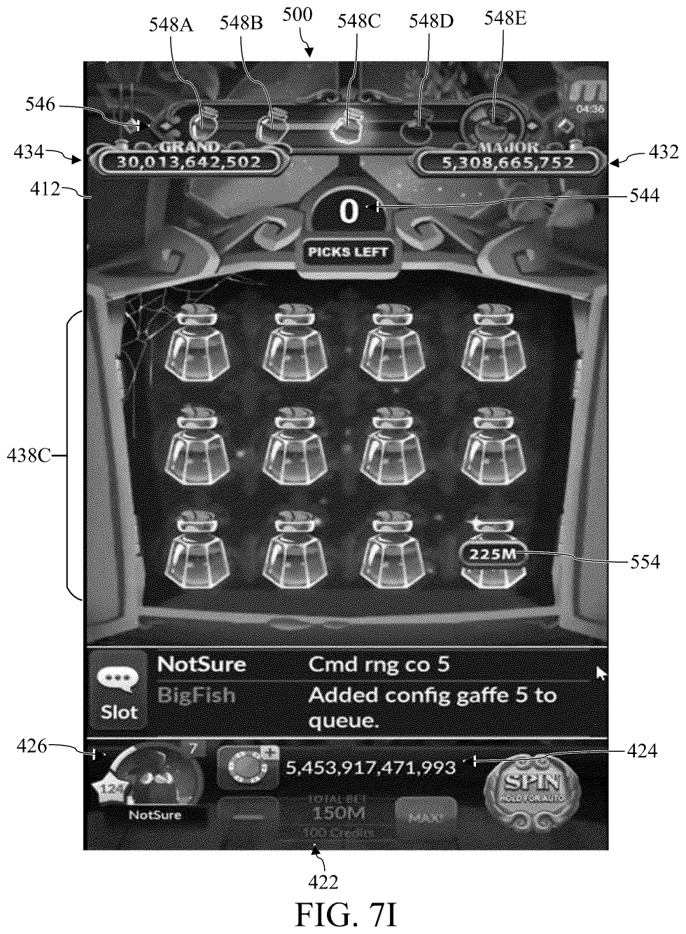

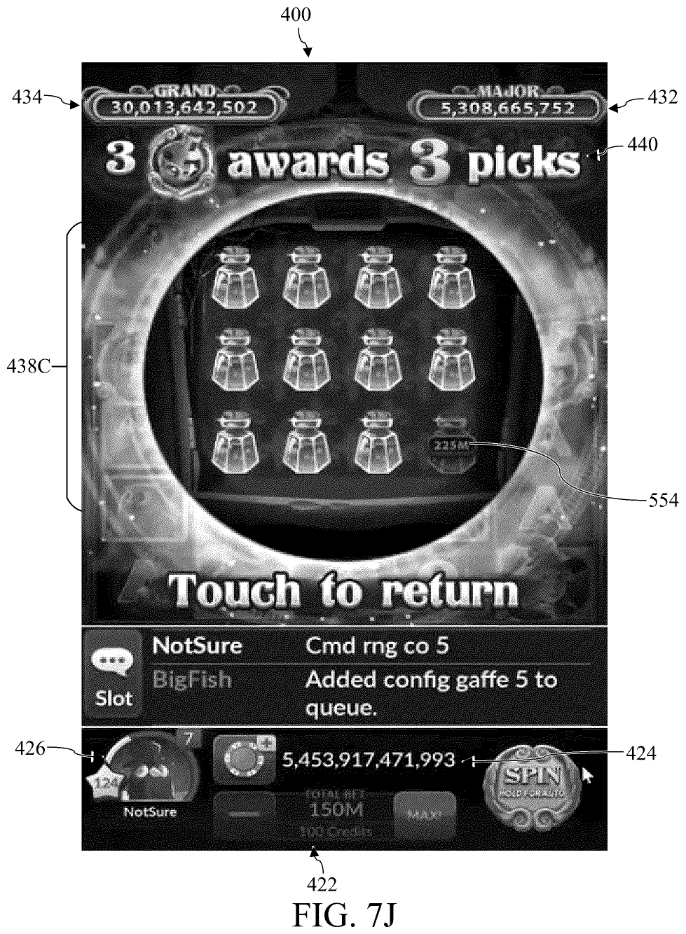

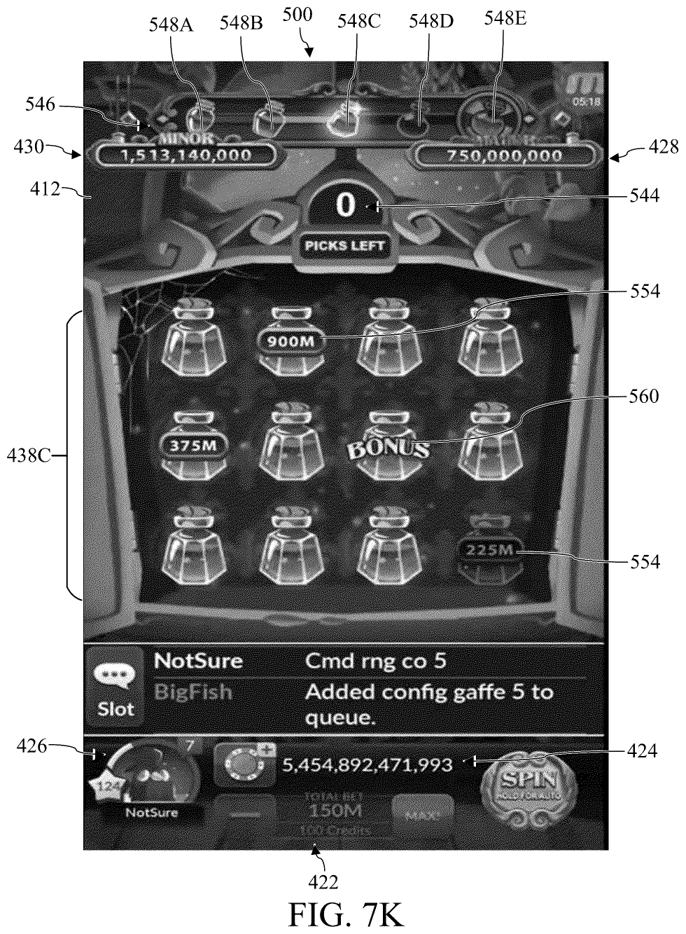

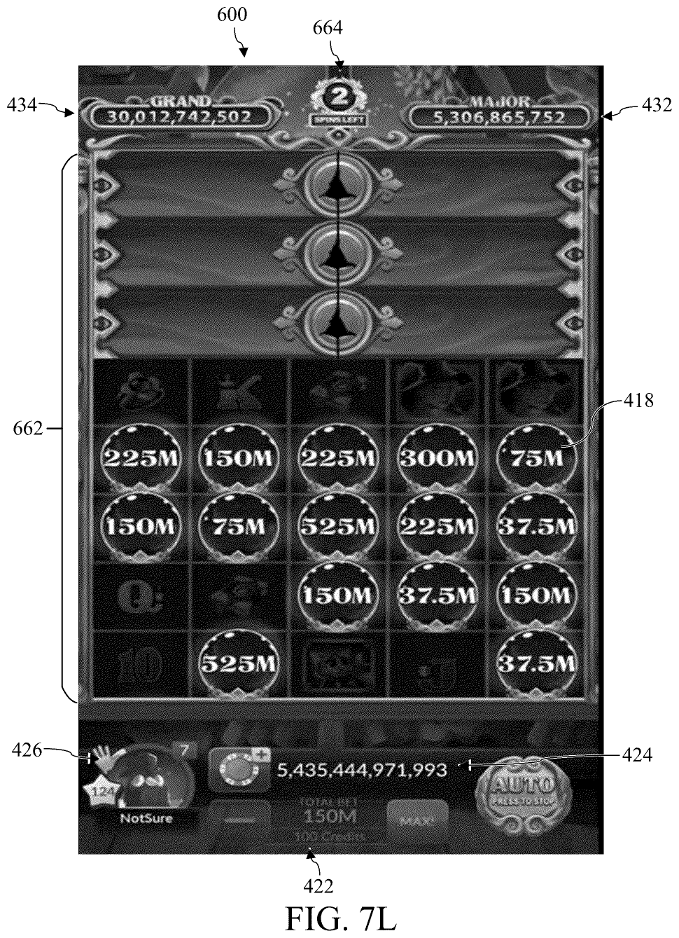

As shown in the exemplary embodiment of FIGS. 4A and 4B, and as discussed herein, the plurality of game symbols 414 included and/or displayed within the plurality of reels 402-410 include and/or are formed from various symbol types. For example, graphic game symbols of the plurality of game symbols 414 include predetermined graphics, symbols, and/or art works that can be based on a theme, story, and/or visual representation of base reel game 400. Additionally, or alternatively, graphic game symbols include suitable graphics, symbols, and/or artworks commonly associated with gaming device (e.g., “BAR,” “SPIN,” “WILD,” etc.). Collectively, these game symbols 414 are referred to herein as graphic symbols 416. Additionally, the plurality of game symbols 414 include cash-on-reel (COR) symbols 418 displayed within the plurality of reels 402-410 (see, FIG. 4A). COR symbols 418 include, display, depict, and/or are associated with a predetermined credit value (e.g., COR credit value) that can provide additional award credits to the player during base reel game 400 and/or can trigger the hold-and-spin bonus games (see, FIG. 7L), as discussed herein. The plurality of game symbols 414 can also include jackpot symbols (not shown), which include, display, depict, and/or are associated with jackpots, as discussed herein. That is, jackpot symbols can provide additional award credits to the player during base reel game 400.

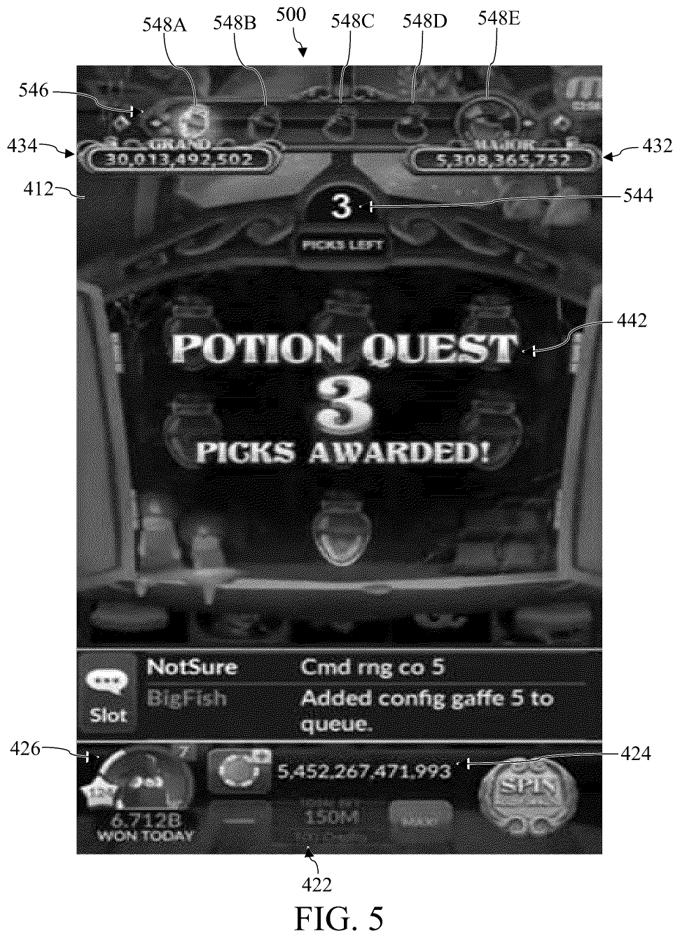

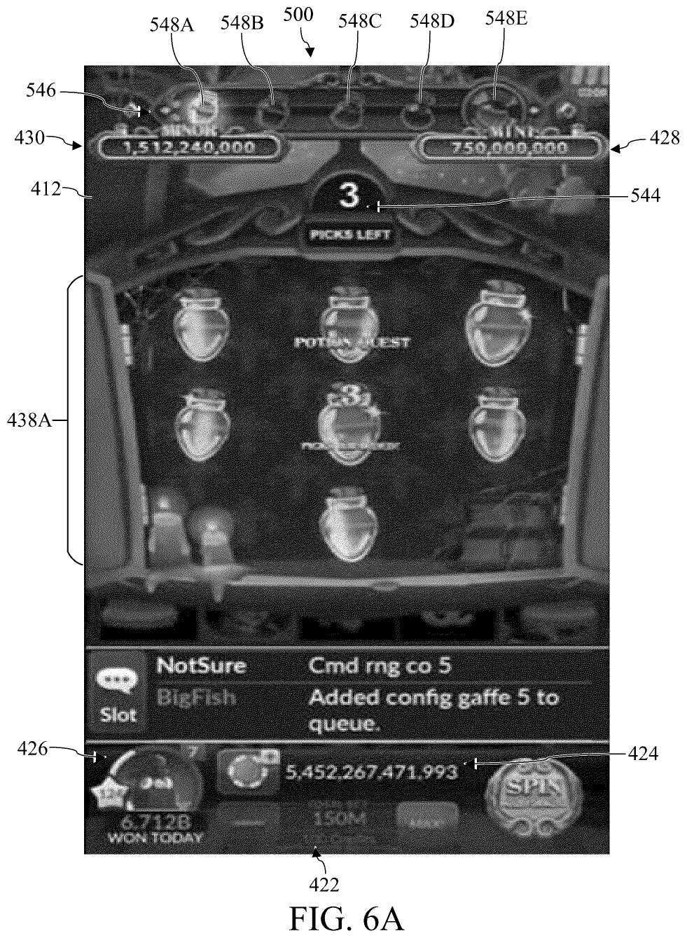

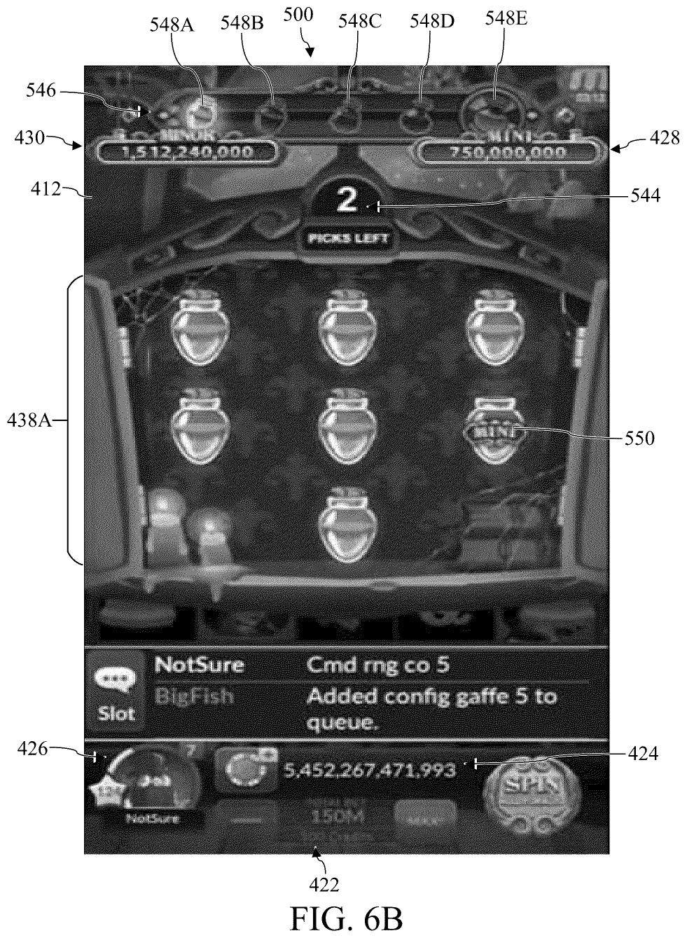

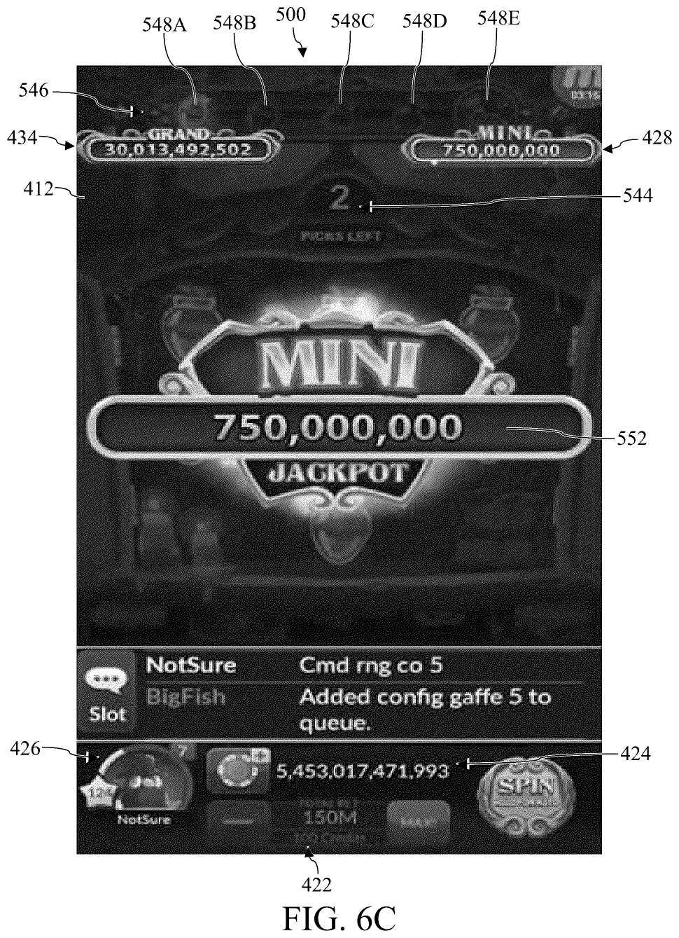

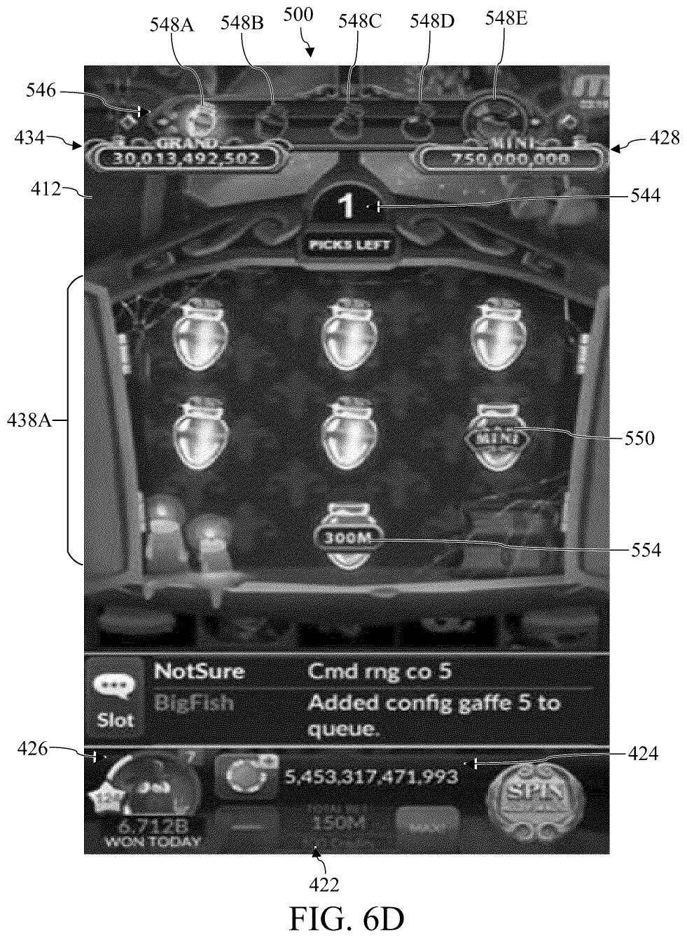

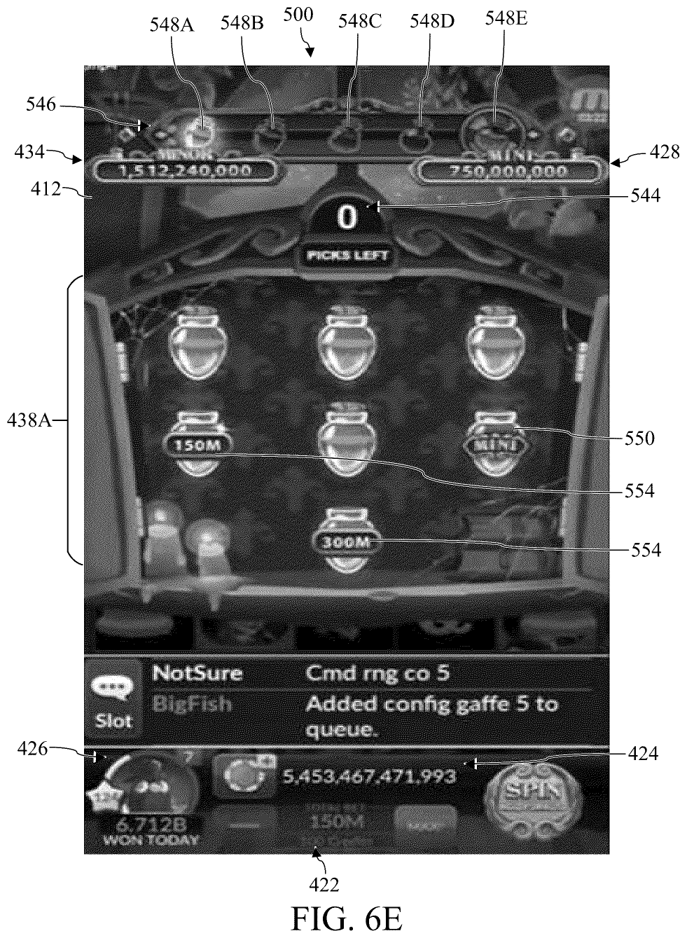

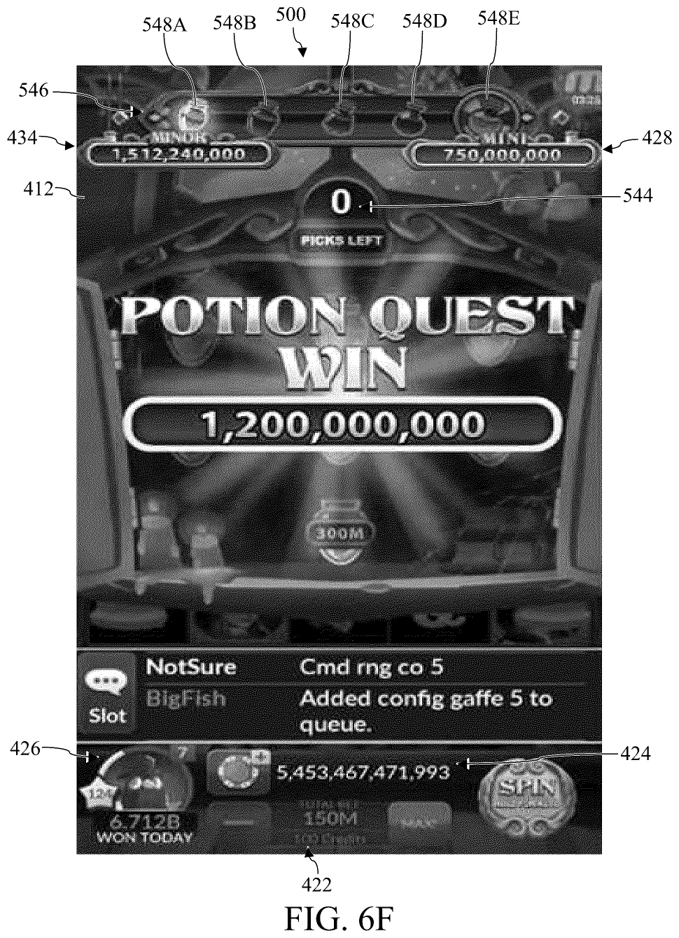

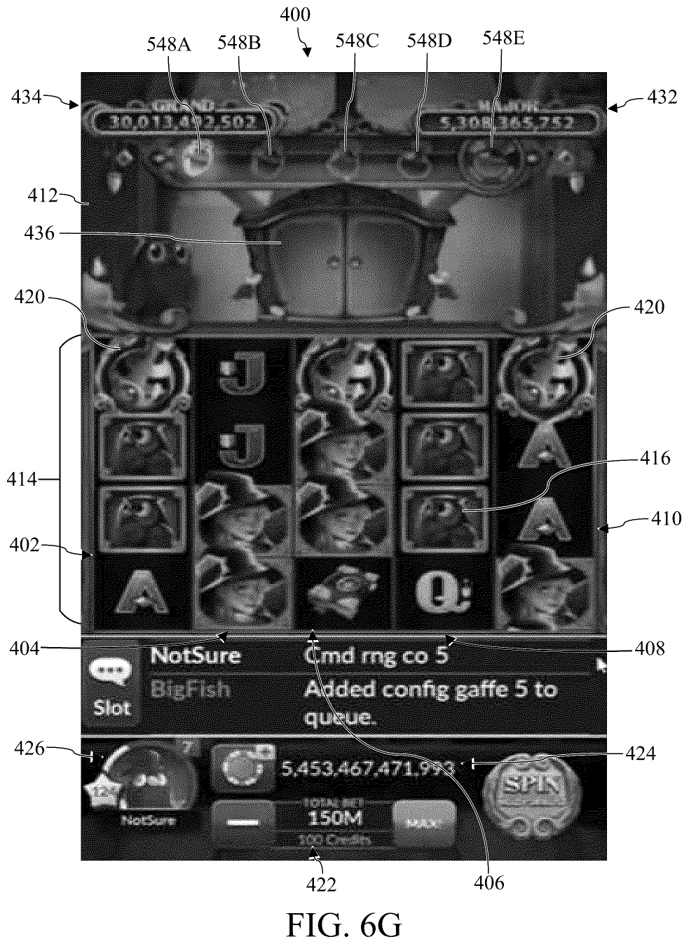

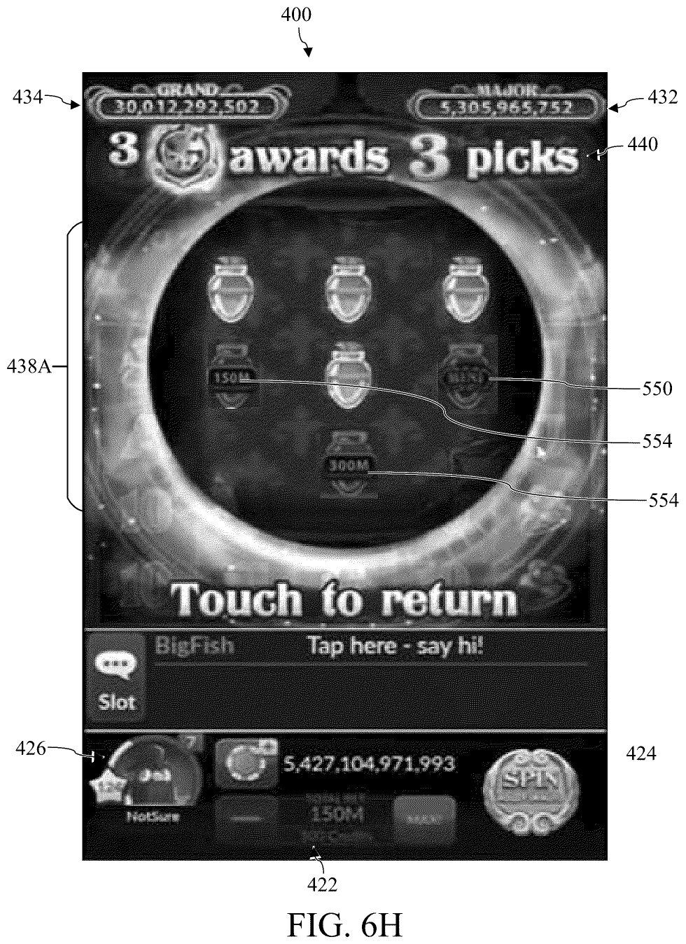

In exemplary embodiments, the plurality of game symbols 414 also include trigger symbols 420. Trigger symbols 420 of the plurality of game symbols 414 can trigger, enable, and/or activate an interactive pick bonus game 500 (see, FIGS. 5 and 6A-6F), as discussed herein. For example, and as discussed herein, where a predetermined number of trigger symbols 420 are displayed in the base reel game outcome, an interactive pick bonus game 500 is activated on display device 412. In the exemplary embodiment shown in FIG. 4B, trigger symbol 420 includes a “potion bottle.” Similar to graphic symbols 416, trigger symbols 420 include predetermined graphics, symbols, and/or art works that can be based on a theme, story, and/or visual representation of base reel game 400 and/or interactive pick bonus game 500.

Base reel game 400 also includes a wager meter 422, and a credit meter 424 depicted on display device 412. Wager meter 422 represents and/or displays the credit and/or monetary value being wagered during each play of base reel game 400, as determined by the player. Credit meter 424 displays a credit balance (calculated as a sum total of credits input and awards accrued minus wagers placed) accrued until a player cashes out. As shown in FIG. 4B, a win meter 426 is also displayed in base reel game 400. As discussed herein, win meter 426 displays a credit and/or monetary value awarded during outcomes of the base reel game 400, hold-and-spin bonus game (see, FIG. 7L), and/or interactive pick bonus game 500, as discussed herein.

In exemplary embodiments, base reel game 400 also displays a plurality of “jackpot” bonuses 428, 430, 432, 434 on display device 412. For example, jackpot bonus 428 includes a “mini” jackpot value (see, FIG. 4B), jackpot bonus 430 includes a “minor” jackpot value (see, FIG. 4B), jackpot bonus 432 includes a “major” jackpot value (see, FIG. 4A), and jackpot bonus 434 includes a “grand” jackpot value (see, FIG. 4A). As discussed herein, each jackpot bonus 428-434 correspond to and/or is correlated with at least one jackpot symbol displayed in the base reel game outcome of base reel game 400, a hold-and-spin outcome of a hold-and-spin game (see, FIG. 7L), and/or an interactive pick bonus game outcome for interactive pick bonus game 500. Additionally, the credit value associated with each jackpot bonus 428-434 may be a predetermined credit value. Alternatively, jackpot bonuses 428-434 include progressive credit values that are dependent upon, at least in part, the credit and/or monetary value being wagered during each play of base reel game 400 (e.g., wager meter 422), the number of consecutive base reel games 400 played prior to triggering hold-and-spin games/interactive pick bonus games, and the like.

As shown in FIGS. 4A and 4B, base reel game 400 also includes an interactive graphical icon 436 (hereafter, “graphical icon 436”) displayed on display device 412, above the plurality of reels 402-410. In exemplary embodiments, graphical icon 436 is shown as a cabinet or wardrobe, however, it is understood that graphical icon 436 can include any suitable predetermined graphic, symbol, and/or artwork that can be based on a theme, story, and/or visual representation of base reel game 400 and/or interactive pick bonus game 500. During base reel game 400 a user or player can interact with graphical icon 436 to view a group of pick bonus game symbols associated with graphical icon 436. For example, and with reference to FIG. 4C, during base reel game 400 a user can touch, tap, and/or interact with graphical icon 436, via touch enabled display device 412, to “open” the cabinet displayed as graphical icon 436 to depict a first group of pick bonus game symbols 438A. Additionally in the exemplary embodiment shown in FIG. 4C instructions or a prompt 440 are displayed on display device 412 to inform the user how interactive pick bonus game 500, and more specifically the first group of bonus game symbols 438A, are accessed, interacted with, and/or triggered (e.g., “3 Potion Bottles awards 3 Picks”).

As discussed herein, during interactive pick bonus game 500, the player or user is provided the ability to interact with and/or tap bonus game symbols 438A to be awarded additional credit values and/or bonus actions features (See, FIGS. 6A-6G). Graphical icon 436 depicted on display device 412 can be interacted with at a variety of times or instances of base reel game 400. For example, a user can touch graphical icon 436 to display the group of bonus game symbols 438A prior to, during, or subsequent to the spinning of the plurality of reels 402-410 while playing base reel game 400. Additionally as discussed herein, bonus game symbols 438A previously selected during prior plays of interactive pick bonus game 500 are persistently displayed during subsequent viewings of bonus game symbols 438A during base reel game 400 and/or during subsequent interactive pick bonus game(s) 500.

During operation, the reel outcome presented during play of the base reel game 400 (e.g., base reel game outcome) corresponds to, presents, represents, and/or is determined from a primary game outcome. For example, the reel outcome (base reel game outcome) may correspond to a primary or underlying Class II game, or the reel outcome may be determined randomly (e.g., in Class III games). Additionally, and as discussed herein, base reel game outcomes and/or conditions of base reel game 400 can trigger hold-and-spin bonus games 600 (see, FIG. 7L) and/or interactive pick bonus game 500, (see, FIG. 6A-6G). For example, and as discussed herein, displaying three (3) trigger symbols 420 (e.g., predetermined number) in the base reel game outcome can trigger interactive pick bonus game 500 on display device 412. Additionally, displaying five (5) or more COR symbols 418 within the plurality of reels 402-410 can trigger hold-and-spin bonus game 600. Moreover, each time COR symbols 418 are displayed within the plurality of reels 402-410 of base reel game 400, the credit values associated with each COR symbol 418 can be added together and/or awarded to the player of gaming device 104.

Turning to FIG. 4D, a user interface or screen shot displaying base reel game outcome of the base reel game 400 is shown. In the exemplary embodiment, the plurality of reels 402-410 include three (3) trigger symbols 420. As discussed herein, the inclusion of three (3) or more trigger symbols 420 within a single outcome of base reel game 400 results in interactive pick bonus game 500 being triggered (see, FIGS. 5A and 6A-6G). Although discussed herein as three (3) or more trigger symbols 420 within a single outcome of base reel game 400 triggering interactive pick bonus game 500, it is to be understood that any predetermined number of trigger symbols 420 displayed during the outcome of base reel game 400 can trigger interactive pick bonus game 500.

Visual and/or auditory cues can be presented to the player to identify that interactive pick bonus game 500 has been triggered based on the outcome of base reel game 400. In the exemplary embodiments, displayed indications can be provided on display device 412 to notify the player that interactive pick bonus game 500 has been triggered as a result of the outcome of base reel game 400. For example, base reel game 400 and subsequent display of interactive pick bonus game 500 may be provided in conjunction with a change to an overlaid translucent or transparent colored graphic effect around display device 412. For instance, in one implementation, display device 412 may change to include a color overlay. The color overlay may be displayed for the duration of interactive pick bonus game 500 to let a player know they are taking part in the hold-and-spin game.

In other implementations, words, symbols, letters, animations, and/or other visual effects may be displayed on display device 412, and/or auxiliary displays, in addition to and/or alternative to the color overlay. FIG. 5 is an exemplary user interface or screen shot after interactive pick bonus game 500 has been triggered as a result of the base reel game outcome (see, FIG. 4D). In the exemplary embodiment, display device 412 shown in FIG. 5 provides a bonus game notification and/or animation 442 (hereafter, “notification 442”) indicating that interactive pick bonus game 500 has been triggered. In the example, bonus game notification 442 may replace and/or overlap the plurality of reels 402-410 of base reel game 400 once interactive pick bonus game 500 is triggered.

Referring to FIGS. 6A-6G, exemplary user interfaces or screenshots of a sequence of interactive pick bonus game 500 initiated after playing base reel game 400 (see, FIGS. 4A-4D) are displayed. The interactive pick bonus game 500 is triggered by the primary game outcome (e.g., base reel game outcome) satisfying a pick bonus game condition, described in further detail herein. In the example implementation, interactive pick bonus game 500 may provide players with various game experiences and/or interactions that can vary from one another and/or provide distinct outcomes and/or awards for the player. In the example implementation, interactive pick bonus game 500 may include a predetermined number of selections or picks for the first group of bonus game symbols 438A. That is, interactive pick bonus game 500 utilizes, includes, and/or facilitates the playing of the game using the first group of bonus game symbols 438A, as well as distinct groups of bonus game symbols, as previously included within, associated with, and/or displayed when a user or player interacts with (e.g., touches) graphical icon 436 displayed during base reel game 400 (see, FIG. 4C). In various implementations, interactive pick bonus game 500 is not limited to a symbol-pick game and may be implemented as another suitable wagering game. However, in the illustrated implementation, interactive pick bonus game 500 is a symbol pick game that includes one or more selections and is initiated after play of the base reel game 400, as discussed herein.

Interactive pick bonus game 500 is triggered in response to a game controller (e.g., the game controller 202) determining that a pick bonus game condition is satisfied by the primary or base reel game outcome. For example, the game controller 202 may determine that at least three (3) trigger symbols 420 were displayed in the base reel game outcome for base reel game 400. In other exemplary embodiments, such as in Class II bingo game implementations, the pick bonus game condition may be a predefined or preselected number of winning bingo patterns included in the bingo game outcome. The game controller 202 may identify and translate the number of winning patterns occurring on the bingo card to triggering interactive pick bonus game 500. In various implementations, a pick bonus game condition may include any suitable trigger condition, such as, for example, generation by RNG 212 of an RNG outcome (e.g., a random number within a range of random numbers) and performing a lookup operation to map the random number to a decision as to whether the pick bonus game condition is satisfied. The RNG outcome for mapping to the decision as to whether the pick bonus game condition is satisfied may be generated after each play of a base game (e.g., the base reel game 400), or may itself be randomly generated based on an additionally generated RNG outcome.

FIG. 6A is an exemplary user interface or screen shot after interactive pick bonus game 500 has been triggered. In the example, interactive pick bonus game 500 may replace and/or overlap reels 402-410 once triggered. Additionally, FIG. 6A depicts interactive pick bonus game 500 prior to a player selection, and/or the first time the first group of pick bonus game symbols 438A are presented to the user. As discussed herein, interactive pick bonus game 500 includes a plurality or first group of selectable, pick bonus game symbols 438A that are presented to the player on display device 412. In the non-limiting example, the first group of selectable, pick bonus game symbols 438A include seven (7) selectable bonus game symbols. In other non-limiting examples, and as discussed herein, distinct pluralities or groups of selectable, pick bonus game symbols 438 can include more than seven (7) symbols (see, FIGS. 7E and 7H).

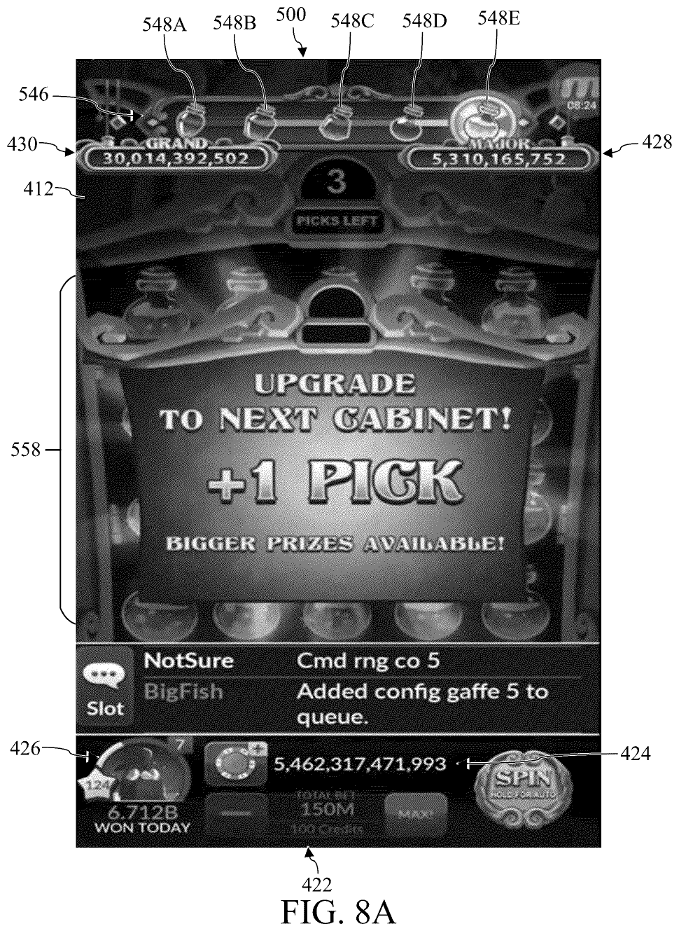

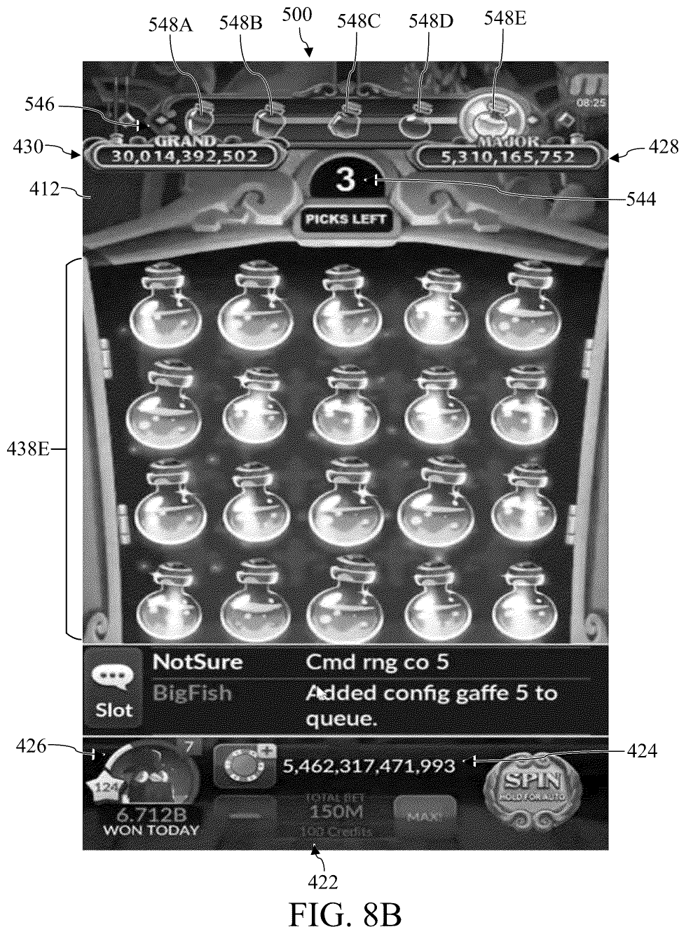

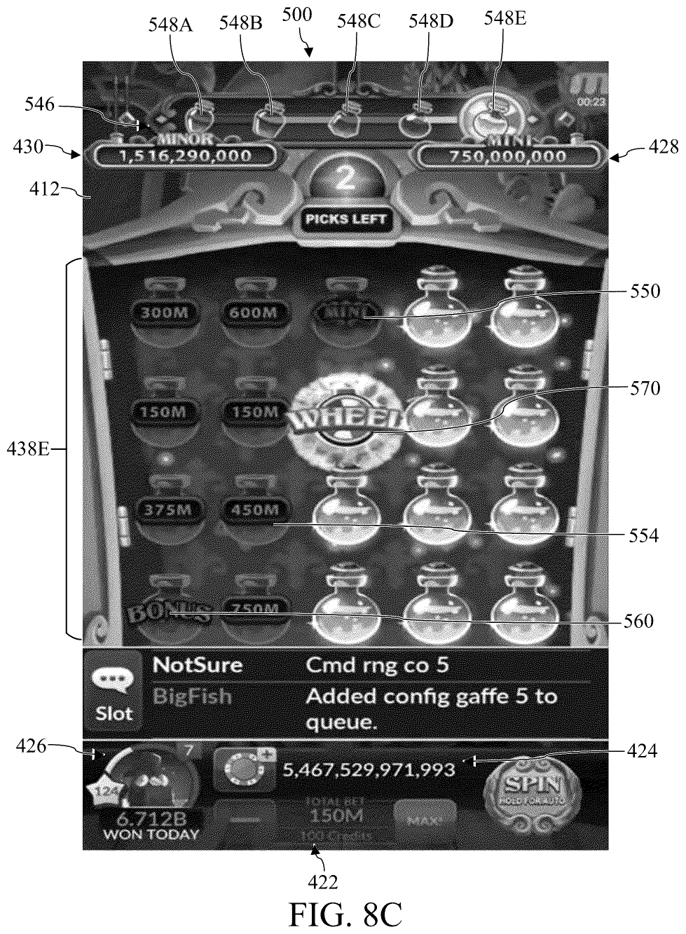

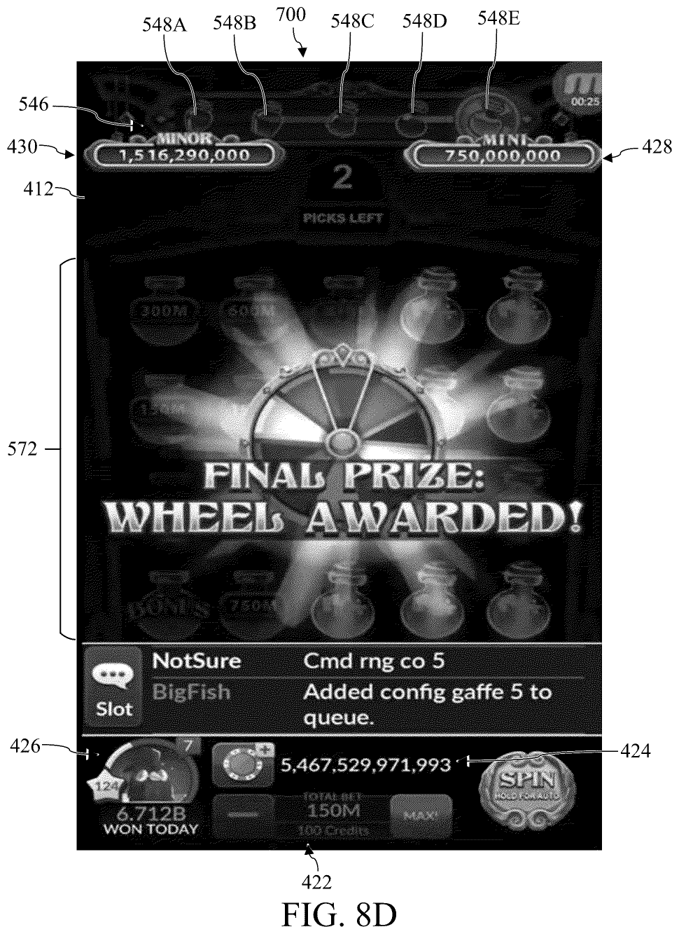

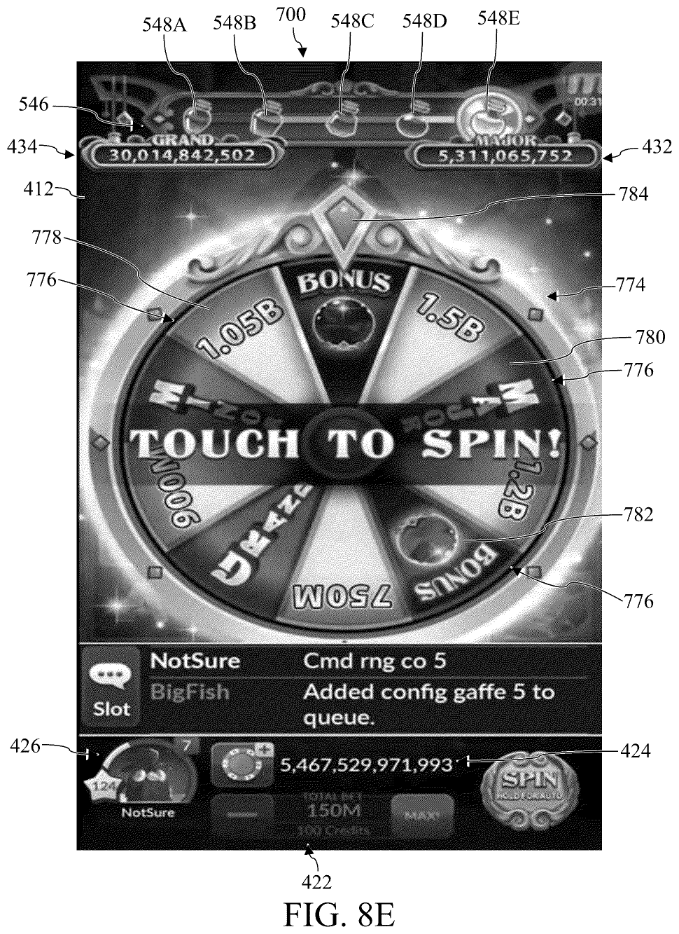

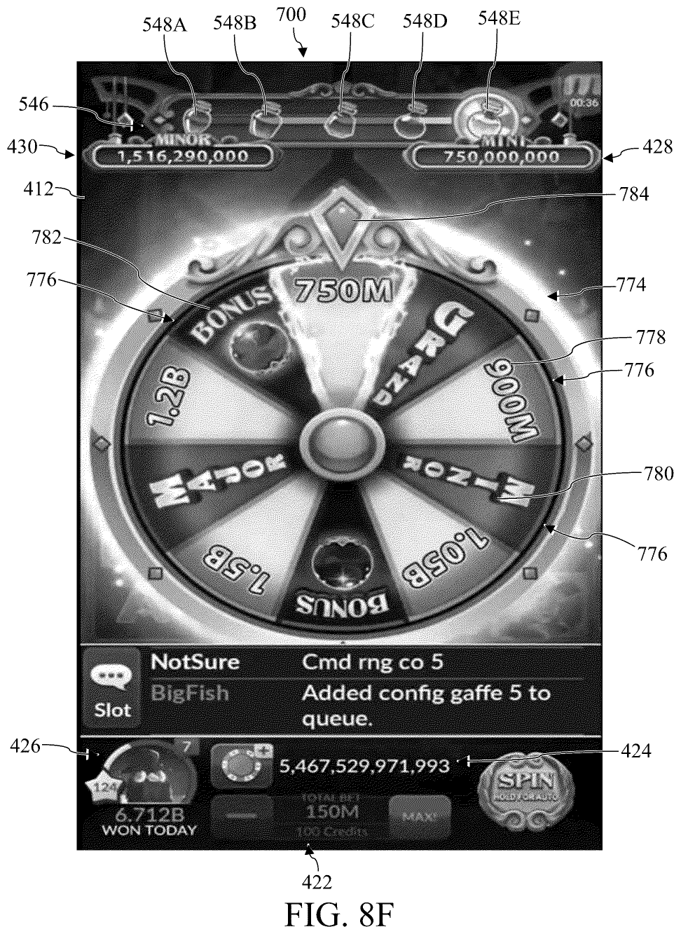

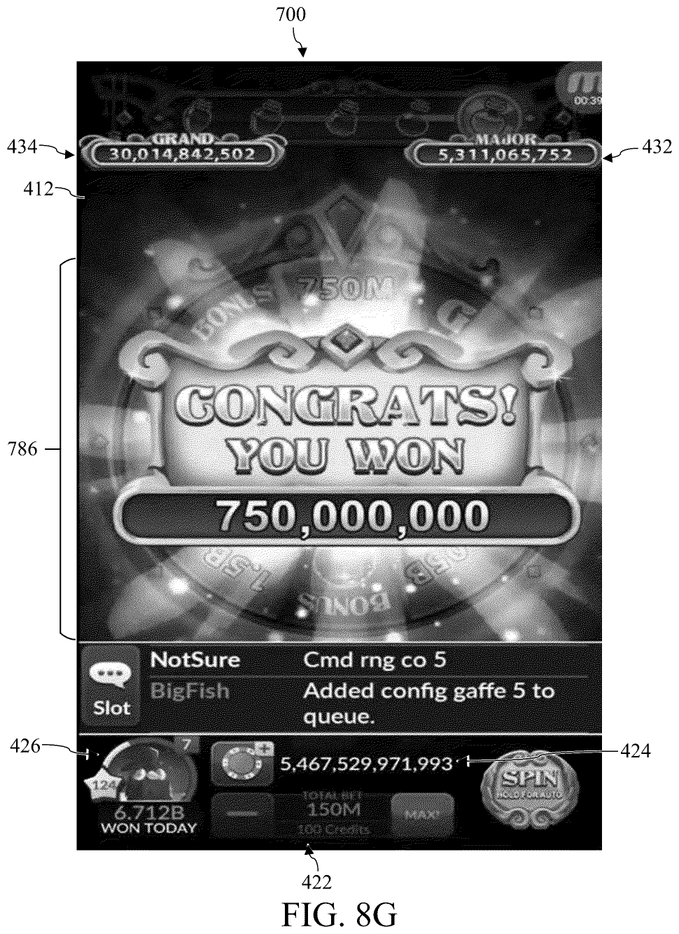

In exemplary embodiments, each pick bonus game symbol of the first group of pick bonus game symbols 438A includes and/or is associated with a credit value or an action feature. Similar to COR symbols 418, the credit value associated with and/or corresponding to any of the pick bonus game symbols 438A are awarded to the player in response to the player selecting or touching the associated pick bonus game symbol 438A during interactive pick bonus game 500 (see, FIG. 6D). Additionally, or alternatively, at least one of the pick bonus game symbols 438A are associated with, correspond to, and/or include an action feature. In exemplary embodiments, action features can include a free pick for adding additional picks to interactive pick bonus game 500, a jackpot feature awarding a credit value associated with jackpot bonuses 428-434 (see, FIGS. 6B and 6C), a hold-and-spin game feature for triggering hold-and-spin game 600 (see, FIGS. 7K and 7L), or a wheel spin feature for triggering a bonus wheel game 700 (see, FIGS. 8C-8G). Additionally, action features can include an upgrade feature for transforming the first group of pick bonus game symbols 438A to a second group of pick bonus game symbols 438B, as discussed herein (see, FIGS. 7B-7I).

Additionally as shown in FIG. 6A, interactive pick bonus game 500 also includes or depicts a pick indicator 544. Prior to picking, selecting, and/or touching one of the pick bonus game symbols of the first group of interactive pick bonus game symbols 438A, pick indicator 544 can display and/or present a predetermined number of picks for interactive pick bonus game 500. In the exemplary embodiment, the predetermined number of picks for interactive pick bonus game 500 is three “3” picks at the start of interactive pick bonus game 500. Although discussed herein as three (3) picks of the first group of interactive pick bonus game symbols 438A for interactive pick bonus game 500, it is to be understood that any predetermined number of picks or selections can be included during the gameplay of interactive pick bonus game 500.

In exemplary embodiments, interactive pick bonus game 500 includes a group indicator 546 as well. Group indicator 546 provides a visual indication and/or graphical representation of the group of interactive pick bonus game symbols 438 that are being presented during interactive pick bonus game 500. As shown in FIG. 6A, group indicator 546 includes five (5) distinct emblems 548A, 548B, 548C, 548D, 548E, where each distinct emblem represents a distinct group of interactive pick bonus game symbols 438. For example, first emblem 548A highlighted, illustrated, and/or animated within group indicator 546 during interactive pick bonus game 500 represents and/or indicates that interactive pick bonus game 500 includes and is presenting the first group of interactive pick bonus game symbols 438A. Alternatively, when third emblem 548C is highlighted, illustrated, and/or animated within group indicator 546 during interactive pick bonus game 500, it represents and/or indicates that interactive pick bonus game 500 includes and is presenting a third group of interactive pick bonus game symbols 438C (see, FIG. 7I). As discussed herein, an upgrade action feature presented, provided, and/or selected during interactive pick bonus game 500 can transform and/or present distinct groups of interactive pick bonus game symbols 438 during interactive pick bonus game 500.

FIG. 6B is an exemplary user interface or screenshot of interactive pick bonus game 500 that shows an exemplary pick bonus game outcome for interactive pick bonus game 500. More specifically, FIG. 6B shows a user interface or screen shot depicting the pick bonus game outcome after the user makes a first selection of the first group of interactive pick bonus game symbols 438A during interactive pick bonus game 500. In the non-limiting example, pick bonus game outcome may award the player the “mini” jackpot value associated with jackpot bonus 428. That is, after the player or user selects one of the pick bonus game symbols included in the first group of interactive pick bonus game symbols 438A, the selected pick bonus game symbol displays, presents, and/or corresponds to a jackpot feature 550 (e.g., jackpot bonus 428 corresponding the mini jackpot). As shown in FIG. 6C, an award credit notification 552 may take the place of and/or overlap the first group of interactive pick bonus game symbols 438A and be displayed on touch enabled display device 412. The awarded credits identified by award credit notification 552 is subsequently added to win meter 426. In the non-limiting example, and as shown in FIG. 6B, the pick value included in pick indicator 544 is also reduced by one (1) as a result of the first pick or selection performed by the user.

FIG. 6D is an exemplary user interface or screen shot that shows a distinct or subsequent pick bonus game outcome for interactive pick bonus game 500. For example, display device 412 shows a distinct, subsequent, or second pick bonus game outcome for a subsequent or second pick for pick bonus game 500. As a result of being the second selection or pick of interactive pick bonus game 500, pick indicator 544 depicts a one (“1”) value for remaining picks or “picks left.” In the non-limiting example, pick bonus game outcome may award the player a “300M” credit value. More specifically, after the player or user selects a distinct symbol of the pick bonus game symbols included in the first group of interactive pick bonus game symbols 438A, the distinct, selected pick bonus game symbol displays, presents, and/or corresponds to a credit value feature 554. As discussed herein, the credit value for the selected pick bonus game symbol 438A corresponding to credit value feature 554 may be dependent upon and/or may include the credit value owed to the player based on the base reel game outcome (e.g., Class III game) or bingo game outcome (e.g., Class II game). The awarded credits identified by credit value feature 554 is subsequently added to win meter 426, or alternatively is added to win meter 426 at the conclusion of interactive pick bonus game 500.

FIG. 6E is an exemplary user interface or screen shot that shows a distinct or subsequent pick bonus game outcome for interactive pick bonus game 500. For example, display device 412 shows a third pick bonus game outcome for a subsequent or third pick for pick bonus game 500. As such, pick indicator 544 depicts a zero (“0”) value for remaining picks or “picks left.” In the non-limiting example, and similar to the second pick shown in FIG. 6D, pick bonus game outcome may award the player a “150M” credit value, after the player or user selects a distinct symbol of the first group of interactive pick bonus game symbols 438A that displays, presents, and/or corresponds to another, distinct credit value feature 554.

FIG. 6F is an exemplary user interface or screen shot after the conclusion or end of interactive pick bonus game 500. For example, at the conclusion or end of interactive pick bonus game 500 (e.g., “0” picks left shown in pick indicator 544), display device 412 provides and/or presents an animation indicating to the player the total credit values awarded during interactive pick bonus game 500. In non-limiting examples, the credit values won and/or awarded during interactive pick bonus game 500 are instantly provided to win meter 426.

At the conclusion or end of interactive pick bonus game 500, touch enabled display device 412 may depict or re-display base reel game 400. FIG. 6G is an exemplary user interface or screen shot of base reel game 400 following the end of interactive pick bonus game 500. In the exemplary embodiment, base reel game 400 including the plurality of reels 402-410 are re-displayed at the end or conclusion of interactive pick bonus game 500.

In addition to re-displaying base reel game 400 and the plurality of reels 402-410, graphical icon 436 is also re-displayed at the end or conclusion of interactive pick bonus game 500. As discussed herein, a user or player can interact with graphical icon 436 to view the first group of pick bonus game symbols 438A associated with graphical icon 436. FIG. 6H is an exemplary user interface or screen shot of the first group of pick bonus game symbols 438A associated with graphical icon 436 following the end of interactive pick bonus game 500. For example, during the re-displaying and/or subsequent gameplay of base reel game 400, a user can touch, tap, and/or interact with graphical icon 436, via touch enabled display device 412, to “open” the cabinet displayed as graphical icon 436 to depict the first group of pick bonus game symbols 438A, as shown in FIG. 6H. In the exemplary embodiments, pick bonus game symbols of the first group of pick bonus game symbols 438A previously selected during interactive pick bonus game 500 (see, FIG. 6E) remain persistent and/or continue to be displayed when interacting with graphical icon 436. That is, previously selected and displayed jackpot feature 550 and credit value feature 554 of the first group of pick bonus game symbols 438A shown in interactive pick bonus game outcome of interactive pick bonus game 500 persist and/or are continuously displayed after the conclusion of interactive pick bonus game 500. Each pick bonus game symbols 438A (e.g., jackpot feature 550 and credit value feature 554) previously displayed during interactive pick bonus game 500 also maintains its position within the first group of pick bonus game symbols 438A when interacting with graphical icon 436. As discussed herein, selected pick bonus game symbols 438A that persist after interactive pick bonus game 500 can continuously be displayed through the redisplaying or additional plays of interactive pick bonus game 500, unless additional conditions are meet (e.g., upgrade feature is selected).

FIGS. 7A-7L are exemplary user interfaces or screenshots of a sequence of interactive pick bonus game 500 initiated after re-playing or re-displaying base reel game 400 (see, FIG. 6G). As discussed herein, FIGS. 7A-7L depict an exemplary sequence of interactive pick bonus game 500 undergoing various upgrades and/or transformations of the group of pick bonus game symbols 438 displayed on touch enabled display device 412.

7A is an exemplary user interface or screen shot after interactive pick bonus game 500 has been re-triggered or re-displayed. In the non-limiting example of FIG. 7A, display device 412 depicts re-displayed interactive pick bonus game 500 prior to a player or user making their first selection of the first group of pick bonus game symbols 438A re-displayed during interactive pick bonus game 500. Pick bonus game symbols 438A that persist after interactive pick bonus game 500 can continuously be displayed through the re-displaying or additional plays of interactive pick bonus game 500. That is, and as shown in FIG. 7A, previously selected and displayed jackpot feature 550 and credit value features 554 of the first group of pick bonus game symbols 438A shown in interactive pick bonus game outcome of interactive pick bonus game 500 persist and/or are continuously displayed during additional gameplays or re-displaying of interactive pick bonus game 500. Each pick bonus game symbols 438A (e.g., jackpot feature 550 and credit value feature 554) previously displayed during interactive pick bonus game 500 also maintains its position within the first group of pick bonus game symbols 438A during the re-displaying of interactive pick bonus game 500 during a subsequent gameplay.

Additionally, as shown in FIG. 7A, previously selected pick bonus game symbols 438A (e.g., jackpot feature 550 and credit value feature 554) are dimmed or shaded during the re-displaying of interactive pick bonus game 500. More specifically, previously selected pick bonus game symbols of the first group of interactive pick bonus game symbols 438A (e.g., jackpot feature 550 and credit value feature 554) are dimmed on display device 412 to indicate to the user or player that the dimmed, pick bonus game symbols may not be selected or reselected in subsequent gameplays of interactive pick bonus game 500.

FIG. 7B is an exemplary user interface or screenshot of interactive pick bonus game 500 that shows an exemplary pick bonus game outcome during the re-displaying of interactive pick bonus game 500. More specifically, FIG. 7B shows a user interface or screen shot depicting the pick bonus game outcome after the user makes a first selection of the first group of interactive pick bonus game symbols 438A during the re-playing or subsequent gameplay of interactive pick bonus game 500. In the non-limiting example, pick bonus game outcome may award the player an upgrade or transformation of the group of interactive pick bonus game symbols 438. That is, after the player or user selects one of the pick bonus game symbols included in the first group of interactive pick bonus game symbols 438A, the selected pick bonus game symbol displays, presents, and/or corresponds to an upgrade feature 556. As discussed herein, upgrade feature 556 corresponding to the selected pick bonus game symbol 438A transforms the first group of pick bonus game symbols 438A to a distinct, or second group of pick bonus game symbols 438B (see, 7E). As shown in FIG. 7B, the pick value included in pick indicator 544 is also reduced by one (1) as result of the first pick or selection performed by the user.

FIG. 7C shows a user interface or screen shot depicting interactive pick bonus game 500 after the user selects upgrade feature 556 from the first group of pick bonus game symbols 438A. In the exemplary embodiment, display device 412 shown in FIG. 7C provides a notification and/or animation indicating that the group of pick bonus game symbols 438 of interactive pick bonus game 500 have been upgraded and/or are undergoing transformation. In the example, group indicator overlaps the first group of pick bonus game symbols 438A when upgrade feature 556 is selected during interactive pick bonus game 500. Second emblem 548B is highlighted, illustrated, and/or animated within group indicator 546 depicted on display device 412 to represent and/or indicate that interactive pick bonus game 500 will present and/or include a second group of interactive pick bonus game symbols 438B during subsequent gameplay and/or picks.

FIG. 7D shows a user interface or screen shot depicting interactive pick bonus game 500 after the user selects upgrade feature 556 from the first group of pick bonus game symbols 438A. In exemplary embodiments a notification 558 is provided to the player or user to indicate that the second group of interactive pick bonus game symbols 438B are included in interactive pick bonus game 500 during subsequent gameplay and/or picks. Notification 558 also indicates and/or instructs the user or player that an additional pick will be added to interactive pick bonus game 500 (e.g., “+1 PICK”). That is, and as a result of previously landing on upgrade feature 556, the player of interactive pick bonus game 500 may regain a pick. For example, pick indicator 544, as shown in FIG. 7E, includes a “3,” indicating to the player that after selecting upgrade feature 556, the player gains their pick back.

In non-limiting examples, at least one of the pick bonus game symbols 438B for the second group is distinct from and/or greater than the pick bonus game symbols 438A of the first group. For example, credit value features 554 associated and/or corresponding to at least a portion of the second group of pick bonus game symbols 438B are equal to or greater than credit value features 554 associated and/or corresponding to the first group of pick bonus game symbols 438A. Additionally, jackpot features 550 associated and/or corresponding to at least a portion of the second group of pick bonus game symbols 438B are equal to or greater than jackpot features 550 associated and/or corresponding to the first group of pick bonus game symbols 438A. For example, the first group of pick bonus game symbols 438A only includes a single jackpot feature 550 corresponding to jackpot bonus 428 (e.g., “mini” jackpot value), while the second group of pick bonus game symbols 438B includes jackpot features 550 corresponding to jackpot bonus 428 and jackpot bonus 430 (e.g., “minor” jackpot value). As shown in FIG. 7D, notification 558 also indicates and/or instructs a user or player that as interactive pick bonus game 500 progresses or upgrades to distinct groups of pick bonus game symbols, the prizes or awards increase (e.g., “BIGGER PRIZES AVAILABLE”).

Additionally, the distinct or second group of pick bonus game symbols 438B includes more pick bonus game symbols than the first group of pick bonus game symbols 438A. For example, FIG. 7E shows a user interface or screen shot depicting interactive pick bonus game 500 after interactive pick bonus game 500 is upgraded to the second group of pick bonus game symbols 438B. Compared to the first group of pick bonus game symbols 438A, which only includes seven (7) symbols, the second group of pick bonus game symbols 438B includes ten (10) symbols. Although ten (10) symbols are shown, the number of symbols included in the second group of pick bonus game symbols 438B can be more or less symbols.

FIG. 7F is an exemplary user interface or screen shot that shows a distinct or subsequent pick bonus game outcome during the re-displaying of interactive pick bonus game 500. For example, display device 412 shows a third pick bonus game outcome for a subsequent or third pick for pick bonus game 500. As such, pick indicator 544 depicts a zero (“0”) value for remaining picks or “picks left.” The previous two picks (e.g., first pick, second pick) include the player or user selecting pick bonus game symbols 438B that included or corresponded to credit value features 554. In the non-limiting example, and similar to the first pick shown in FIG. 7B, pick bonus game outcome also includes displaying upgrade feature 556 included in the second group of pick bonus game symbols 438B. That is, for the third pick, the user or player selected pick bonus game symbol of the second group of pick bonus game symbols 438B that corresponds to upgrade feature 556.

As a result of selecting upgrade feature 556 from the second group of pick bonus game symbols 438B, similar progressions, animations, and/or notifications are provided to the user as discussed herein with respect FIGS. 7B-7D. For example, FIG. 7G shows a user interface or screen shot depicting interactive pick bonus game 500 after the user selects upgrade feature 556 from the second group of pick bonus game symbols 438B. In the exemplary embodiment, group indicator overlaps the second group of pick bonus game symbols 438B when upgrade feature 556 is selected during interactive pick bonus game 500. Third emblem 548C is highlighted, illustrated, and/or animated within group indicator 546 depicted on display device 412 to represent and/or indicate that interactive pick bonus game 500 will present and/or include a third group of interactive pick bonus game symbols 438C during subsequent gameplay and/or picks.

Additionally, it is understood that display device 412 can also present a similar notification 558 to the player or user to indicate that the third group of interactive pick bonus game symbols 438C are included in interactive pick bonus game 500 during subsequent gameplay and/or picks, as shown and discussed herein with respect to FIG. 7D. As a result of previously landing on upgrade feature 556, the player of interactive pick bonus game 500 regains a pick during interactive pick bonus game 500. For example, pick indicator 544, as shown in FIG. 7H, includes a “1,” indicating to the player that after selecting upgrade feature 556, the player gains their pick back.

FIG. 7I is an exemplary user interface or screen shot that shows a distinct or subsequent pick bonus game outcome for interactive pick bonus game 500. For example, display device 412 shows a final pick bonus game outcome for a subsequent pick for pick bonus game 500. As such, pick indicator 544 depicts a zero (“0”) value for remaining picks or “picks left.” In the non-limiting example, pick bonus game outcome may award the player a “225M” credit value, after the player or user selects a distinct symbol of the third group of interactive pick bonus game symbols 438C that displays, presents, and/or corresponds to another, distinct credit value feature 554.

FIG. 7J is an exemplary user interface or screen shot of the third group of pick bonus game symbols 438C associated with graphical icon 436 following the end of the re-displaying and/or subsequent game play of interactive pick bonus game 500 (see, FIGS. 7A-7I). For example, during the re-displaying and/or subsequent gameplay of base reel game 400, a user can touch, tap, and/or interact with graphical icon 436, via touch enabled display device 412, to “open” the cabinet displayed as graphical icon 436 to depict third group of pick bonus game symbols 438C, after a player has selected multiple upgrade feature 556 during interactive pick bonus game 500. In the exemplary embodiments, the pick bonus game symbol of the third group of pick bonus game symbols 438C previously selected during interactive pick bonus game 500 (see, FIG. 7I) remain persistent and/or continue to be displayed when interacting with graphical icon 436. That is, previously selected and displayed credit value feature 554 of the third group of pick bonus game symbols 438C shown in interactive pick bonus game outcome of interactive pick bonus game 500 persists and/or is continuously displayed after the conclusion of interactive pick bonus game 500, as discussed herein.

7K is an exemplary user interface or screen shot that shows a distinct or subsequent pick bonus game outcome during additional re-displaying and/or subsequent gameplay of interactive pick bonus game 500. For example, display device 412 shows a third pick bonus game outcome for a subsequent or third pick for pick bonus game 500. As such, pick indicator 544 depicts a zero (“0”) value for remaining picks or “picks left.” The previous two picks (e.g., first pick, second pick) include the player or user selecting pick bonus game symbols 438C that included or corresponded to credit value features 554. In the non-limiting example, pick bonus game outcome also includes displaying hold-and-spin bonus game feature 560 included in the third group of pick bonus game symbols 438C. That is, for the third pick, the user or player selected pick bonus game symbol of the third group of pick bonus game symbols 438C that corresponds to hold-and-spin bonus game feature 560. The selection of hold-and-spin bonus game feature 560 triggers a hold-and-spin bonus game 600.

FIG. 7L is an exemplary user interface or screen shot depicting hold-and-spin bonus game 600. In exemplary embodiments, hold-and-spin bonus game 600 includes a plurality of hold-and-spin reels 662 displaying a plurality of COR symbols 418. During hold-and-spin bonus game 600, a spin number indicator 664 may be displayed and/or presented to the player on display device 412. Prior to “spinning” the plurality of reels 662, spin number indicator 664 can display and/or present a predetermined number of bonus spins for hold-and-spin game 500. In exemplary embodiments, the predetermined number of bonus spins for hold-and-spin game 600 is three (3). The user or player of hold-and-spin bonus game 600 “spins” the plurality of reels 662 to attempt to display additional COR symbols 418 thereon. Each spin in which one or more COR symbol 418 lands or is displayed on at least one reel 662 of hold-and-spin bonus game 600 resets the spin number indicator 664 back to the predetermined number of spins for hold-and-spin bonus game 600. In another non-limiting example, the number of bonus spins are not reset in response to displaying COR symbols 418 during hold-and-spin game 600. Rather, the player can spin hold-and-spin game 600 the predetermined number of spins (e.g., three spins), before hold-and-spin game 600 ends. At the end of hold-and-spin bonus game 600, the credit values corresponding to and/or included with COR symbols 418 displayed in reels 662 are added to win meter 426, or alternatively, are combined with the total award or credit value presented to the user at the end of interactive pick bonus game 500.

Although discussed herein as a reel-based bonus game, it is understood that hold-and-spin game 600 is configured as any suitable bonus game that can provide additional game play and/or increased chances for the user or player to win additional credit values.

FIGS. 8A-8H are exemplary user interfaces or screenshots of a sequence of interactive pick bonus game 500 initiated after re-playing or re-displaying base reel game 400 (see, FIG. 6G). Specifically, upgrade transformation to distinct or final game symbols 438E.

FIGS. 8A-8G are exemplary user interfaces or screenshots of a sequence of interactive pick bonus game 500 initiated after re-playing or re-displaying base reel game 400 (see, FIG. 6G). As discussed herein, FIGS. 8A-8G depict an exemplary sequence of interactive pick bonus game 500 undergoing various upgrades and/or transformations of the group of pick bonus game symbols 438 and the triggering of a bonus wheel game 700 displayed on touch enabled display device 412.

FIG. 8A shows a user interface or screen shot depicting interactive pick bonus game 500 after the user selects upgrade feature 556 from the fourth group of pick bonus game symbols 438D (not shown). In exemplary embodiments, notification 558 is provided to the player or user to indicate that the fifth group of interactive pick bonus game symbols 438E are included in interactive pick bonus game 500 during subsequent gameplay and/or picks. Furthermore, fifth emblem 548E is highlighted, illustrated, and/or animated within group indicator 546 depicted on display device 412 to represent and/or indicate that interactive pick bonus game 500 will present and/or include fifth group of interactive pick bonus game symbols 438E during subsequent gameplay and/or picks. Notification 558 also indicates and/or instructs the user or player that an additional pick will be added to interactive pick bonus game 500 (e.g., “+1 PICK”). That is, and as a result of previously landing on upgrade feature 556, the player of interactive pick bonus game 500 may regain a pick.

FIG. 8B shows a user interface or screen shot depicting interactive pick bonus game 500 after interactive pick bonus game 500 is upgraded to the fifth group of pick bonus game symbols 438E. As discussed herein, the distinct or fifth group of pick bonus game symbols 438E includes more pick bonus game symbols than the preceding groups of pick bonus game symbols 438A, 438B, 438C, 438D. For example, and compared to the third group of pick bonus game symbols 438C, which only includes twelve (12) symbols (see, FIG. 7H), the fifth group of pick bonus game symbols 438E includes twenty (20) symbols. Although twenty (20) symbols are shown, the number of symbols included in the fifth group of pick bonus game symbols 438E can be more or less symbols.

FIG. 8C is an exemplary user interface or screen shot that shows a distinct or subsequent pick bonus game outcome during the re-displaying of interactive pick bonus game 500. For example, display device 412 shows a pick bonus game outcome after multiple gameplays or re-displaying's of interactive pick bonus game 500. In the exemplary embodiment, nine (9) previously selected pick bonus game symbols 438E are dimmed. The previously selected pick bonus game symbols include jackpot feature 550, a plurality of credit value features 554, and hold-and-spin bonus game feature 560, respectively.

Additionally, FIG. 8C depicts the most recent symbol selected and/or picked by the user on display device 412. In the non-limiting example, pick bonus game outcome may trigger a bonus wheel game 700. That is, after the player or user selects one of the pick bonus game symbols included in the fifth group of interactive pick bonus game symbols 438E, the selected pick bonus game symbol displays, presents, and/or corresponds to a wheel spin feature 570. As discussed herein, wheel spin feature 570 corresponds to and/or triggers bonus wheel game 700 on display device 412. In exemplary embodiments, wheel spin feature 570 is only included in and/or corresponds to one symbol of the fifth group of interactive pick bonus game symbols 438E, or alternatively, can be included in each of the distinct groups of interactive pick bonus game symbols 438A-438E.

FIG. 8D shows a user interface or screen shot depicting interactive pick bonus game 500 after the user selects wheel spin feature 570 from the fifth group of pick bonus game symbols 438E. In exemplary embodiments a notification 572 is provided to the player or user to indicate that bonus wheel game 700 has been triggered. Notification 572 also indicates and/or instructs the user or player that the triggering of bonus wheel game 700 results in a final prize or credit value award opportunity (e.g., “FINAL PRIZE: WHEEL AWARDED”).

FIG. 8E shows a user interface or screen shot depicting bonus wheel game 700 after being triggered within pick bonus game 500, and prior to the “spinning” of bonus wheel 774. In exemplary embodiments, bonus wheel game 700 depicted on display device 412 includes bonus wheel 774. Bonus wheel 774 of bonus wheel game 700 includes a plurality of wedges 776. More specifically, bonus wheel 774 is formed and/or divided into a plurality of distinct wedges 776 disposed circumferentially about a center reference point. In the non-limiting example shown, each wedge 776 for bonus wheel 774 is sized equally. However, in other non-limiting examples (not shown), the plurality of wedges 776 may include distinct sizes with respect to one another. Each wedge of the plurality of wedges 776 depicts a credit value feature 778, a jackpot feature 780, or a hold-and-spin feature 782. The credit value feature 778 depicted, displayed, and/or associated with each wedge of the plurality of wedges 776 represents a predetermined credit value that can provide additional award credits to the player during bonus wheel game 700, as discussed herein. Jackpot feature 780 of wedge(s) 776 are associated with and/or correspond to an indicated jackpot bonus 428-434 discussed herein. Additionally, hold-and-spin feature 782 of wedge(s) 776 are associated with and/or can trigger hold-and-spin bonus game 600, as discussed herein (see, FIG. 7L).

In an exemplary embodiment, credit value feature 778, jackpot feature 780, and/or hold-and-spin feature 782 included within the plurality of wedges 776 are randomly generated and presented to the user or player on display device 412 during bonus wheel game 700. Alternatively, credit value feature 778, jackpot feature 780, and/or hold-and-spin feature 782 corresponding to each of the plurality of wedges 776 include the credit value(s) or the action feature(s) associated with each unselected pick bonus game symbol 438E of the fifth group. For example, and with reference to FIG. 8C, ten (10) of the fifth group of pick bonus game symbols 438E remain unselected when the user selects or picks wheel feature 570. As a result, each corresponding or associated jackpot feature 550, credit value feature 554, and/or hold-and-spin bonus game feature 560 for the ten (10) unselected pick bonus game symbols 438E can form, translate, and/or define credit value feature 778, jackpot feature 780, and/or hold-and-spin feature 782 for each of the plurality of wedges 776 of bonus wheel game 700. In the exemplary embodiment, because there are ten (10) unselected pick bonus game symbols 438E, bonus wheel 774 of bonus wheel game 700 includes ten (10) wedges 776. That is, the number of unselected pick bonus game symbols 438E of the fifth group define the number of wedges 776 forming bonus wheel 774 during bonus wheel game 700. Although ten wedges 776 are shown, it is understood that bonus wheel 774 can include any number of wedges 776 between one (1) and nineteen (19), where fifth group of pick bonus game symbols 438E includes twenty (20) symbols.

Bonus wheel game 700 also includes at least one pointer 784. Pointer 784 is positioned adjacent to bonus wheel 774. During the spin and/or game play of bonus wheel game 700, pointer 784 visually identifies the wedge 776 of bonus wheel 774 that has been selected and/or awarded to the player. As shown in FIG. 8E, pointer 784 is formed and/or depicted as a diamond shape. However, it should be understood that pointer 784 can be formed as any shape, symbol, figure, and/or graphic that can readily identify wedges 776 of bonus wheel 774 during bonus wheel game 700.

FIG. 8F is an exemplary user interface or screenshot of bonus wheel game 700 that shows an exemplary bonus wheel game outcome for bonus wheel game 700. More specifically, FIG. 8F shows a user interface or screen shot depicting the bonus wheel game outcome for the spin for bonus wheel game 700. In the non-limiting example, bonus wheel game outcome awards the player “750M” credits. That is, when bonus wheel 774 stops spinning, pointer 784 of bonus wheel game 700 identifies wedge 776 that includes and/or corresponds to credit value feature 778 equal to or depicting “750M” credits. The awarded credits identified in wheel 774 are subsequently added to win meter 422.

FIG. 8G shows a user interface or screen shot depicting the end or conclusion of bonus wheel game 700. In exemplary embodiments, a notification 786 is provided to the player or user to indicate that bonus wheel game 700 is concluded. Notification 786 also indicates to the user or player the final prize or credit value awarded during bonus wheel game 700 (e.g., “CONGRATS! YOU WON 750,000,000”).

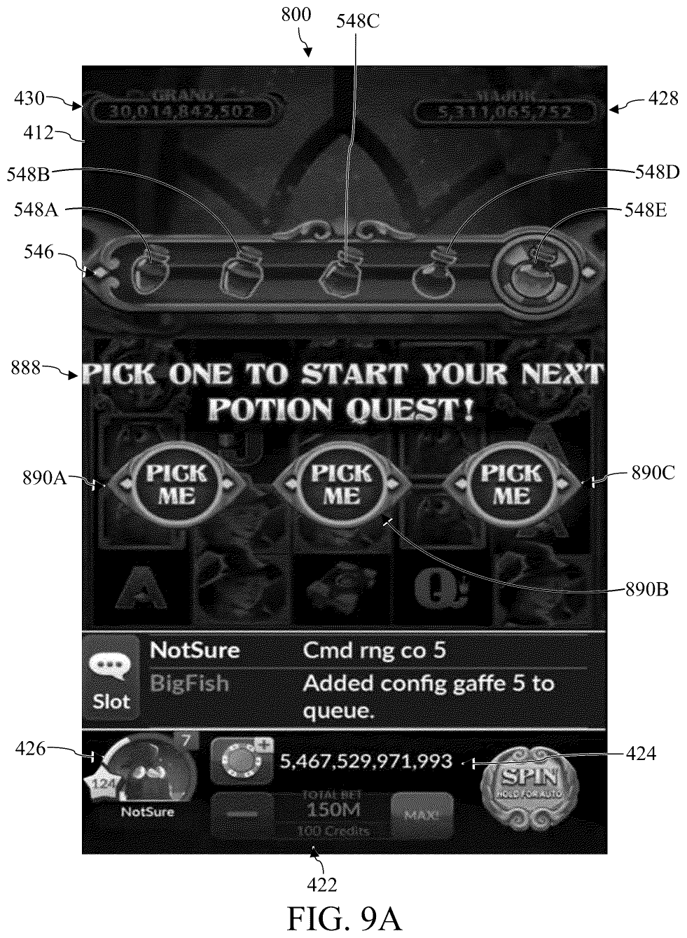

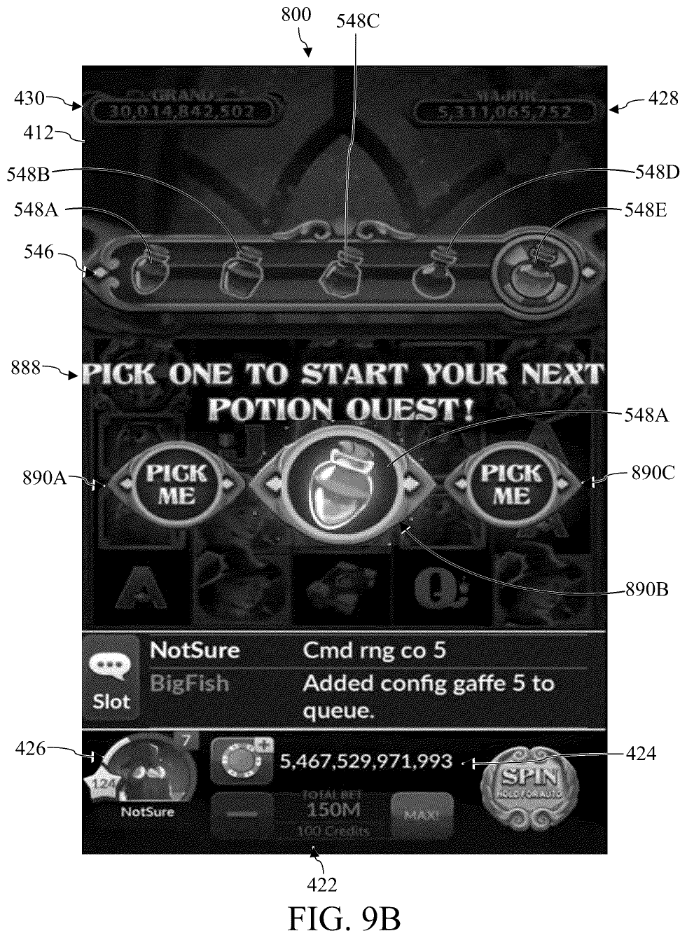

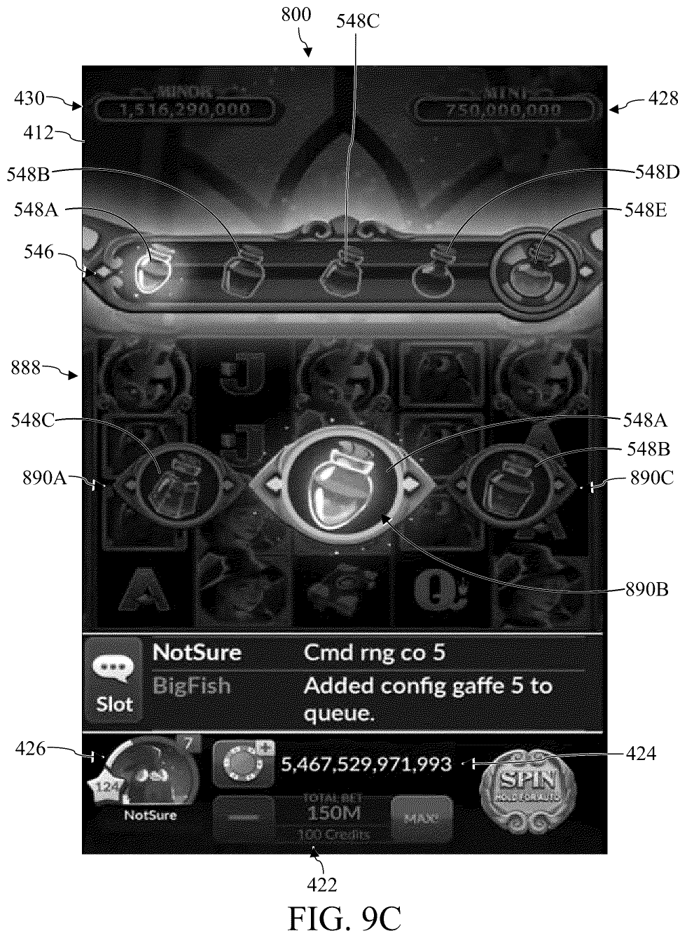

The completion or end of bonus wheel game 700 also triggers a unique or distinct pick bonus game 800. That is, upon completing the final spin for bonus wheel game 700, distinct pick bonus game 800 is triggered for the player or user. FIGS. 9A-9C are exemplary user interfaces or screenshots of a sequence of distinct pick bonus game 800 initiated and/or triggered after completing bonus wheel game 700. As discussed herein, concluding bonus wheel game 700 can trigger the displaying and/or playing of distinct pick bonus game 800.

FIG. 9A is an exemplary user interface or screen shot after distinct pick bonus game 800 has been triggered. In the exemplary embodiment, display device 412 shown in FIG. 9A provides a bonus game notification and/or animation 888 indicating that distinct pick bonus game 800 has been triggered, and also provides game instructions (e.g., “PICK ONE TO START YOUR NEXT POTION QUEST”). In the example, distinct pick bonus game 800 replaces and/or overlaps base reel game 400 once triggered. Additionally, FIG. 9A depicts distinct pick bonus game 800 prior to a player selection. Distinct pick bonus game 800 includes a plurality of distinct, selectable pick game symbols 890 that are presented to the player on display device 412. In the non-limiting example, three distinct pick game symbols 890A, 890B, 890C are included in distinct pick bonus game 800. In other non-limiting examples, the plurality of distinct pick game symbols 890 can include more or less than three (3) symbols and/or may continuously move in a random pattern.

In exemplary embodiments, each of the plurality of distinct pick game symbols 890A, 890B, 890C are associated with one of the groups of pick bonus game symbols 438A-438E. For example, and as discussed herein, each of the plurality of distinct pick game symbols 890A, 890B, 890C displayed during pick bonus game 700 are associated with and/or correspond to one of the first group of pick bonus game symbols 438A, the second group of pick bonus game symbols 438B, the third group of pick bonus game symbols 438C, the fourth group of pick bonus game symbols 438D, or the fifth group of pick bonus game symbols 438E. However, prior to picking or selecting one of the plurality of distinct pick game symbols 890A, 890B, 890C, the associated pick bonus game symbols 438A-438E for each distinct pick game symbols 890A, 890B, 890C are not displayed to the player, as shown in FIG. 9A.

Additionally as shown in FIG. 9A, group indicator 546 is reset at the conclusion of bonus wheel game 700 and/or upon triggering distinct pick bonus game 800. Specifically, none of the distinct emblems 548A-548E included in group indicator 546 and associated with the distinct groups of pick bonus game symbols 438A-438E, are highlighted, illustrated, and/or animated within group indicator 546. As discussed herein, the distinct pick game symbols 890A, 890B, 890C selected during distinct pick bonus game 800 defines the group of pick bonus game symbols 438A the player or user initially selects from during the first instance or play of interactive pick bonus game 500 after distinct pick bonus game 800.

FIG. 9B is an exemplary user interface or screen shot after one of the plurality of distinct pick game symbols 890A, 890B, 890C is selected by the player. In the non-limiting example, distinct pick game symbol 890B is selected and/or picked by the player. As a result, first emblem 548A is shown on display device 412. That is, first emblem 548A, and corresponding first group of pick bonus game symbols 438A, is assigned and/or associated with distinct pick game symbol 890B. As such, when the player selects or picks distinct pick game symbol 890B during distinct pick bonus game 800, display device 412 displays or visually depicts first emblem 548A associated with distinct pick game symbol 890B. The provided emblem 548A indicates to the player that the next instance in which they play interactive pick bonus game 500 after distinct pick bonus game 800 ends will include selecting from the first group of interactive pick bonus game symbols 438A.

Briefly turning to FIG. 9C, in exemplary embodiments where the player or user would have selected distinct pick game symbol 890A, subsequent plays of interactive pick bonus game 500, after distinct pick bonus game 800, will include selecting from the third group of interactive pick bonus game symbols 438C. That is, third emblem 548C, and corresponding third group of pick bonus game symbols 438C, is assigned and/or associated with distinct pick game symbol 890A. As such, when the player selects or picks distinct pick game symbol 890A during distinct pick bonus game 800, display device 412 displays or visually depicts third emblem 548C associated with distinct pick game symbol 890A. The provided emblem 548C indicates that interactive pick bonus game 500 will include selecting from the third group of interactive pick bonus game symbols 438C during the first gameplay of interactive pick bonus game 500 after distinct pick bonus game 800 ends.

In exemplary embodiments each emblem 548A-548E, and associated groups of pick bonus game symbols 438A-438E, is assigned to one of the plurality of selectable pick game symbols 890A, 890B, 890C prior to the selection of distinct pick game symbols 890A, 890B, 890C. As a result, the selection of the corresponding emblem 548A-548E during distinct pick bonus game 800 is random and/or equally weighted for the player.

FIG. 9C is an exemplary user interface or screen shot after one of the plurality of selectable pick game symbols 890A, 890B, 890C is selected by the player, and prior to redisplaying base reel game 400. In the exemplary embodiment, unselected emblems 548B, 548C associated within distinct pick game symbols 890A, 890C, respectively, are displayed on display device 412. That is, and to increase player excitement, in response to one of the plurality of distinct pick game symbols 890A, 890B, 890C being selected, display device 412 displays emblems 548B, 548C associated with the unselected distinct pick game symbols 890A, 890C. Additionally in exemplary embodiments, first emblem 548A is highlighted, illustrated, and/or animated within group indicator 546 during distinct pick bonus game 800. The highlighting of first emblem 548A within group indicator 546 represents and/or indicates that subsequent interactive pick bonus games 500 will start by presenting the first group of interactive pick bonus game symbols 438A, as a result of the outcome of distinct pick bonus game 800.

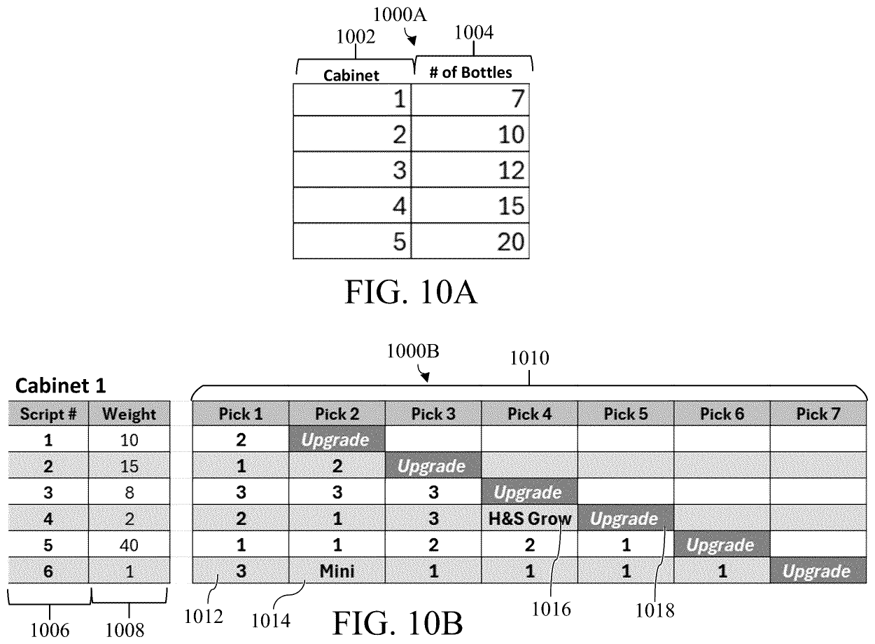

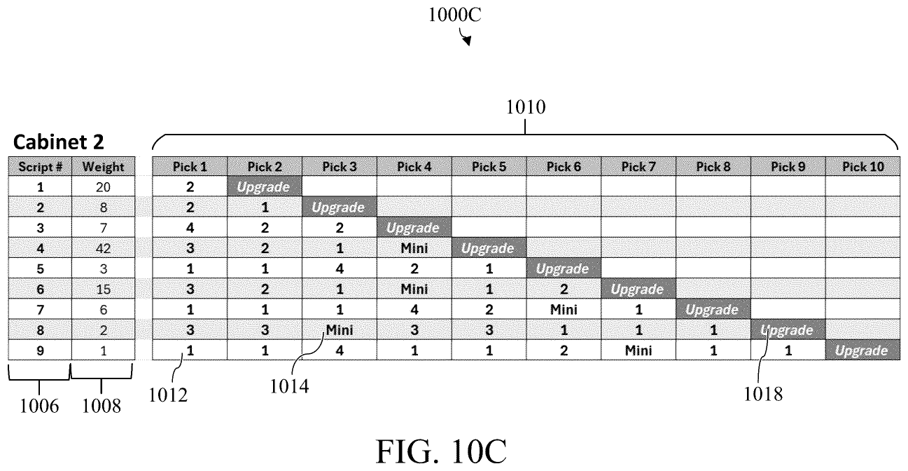

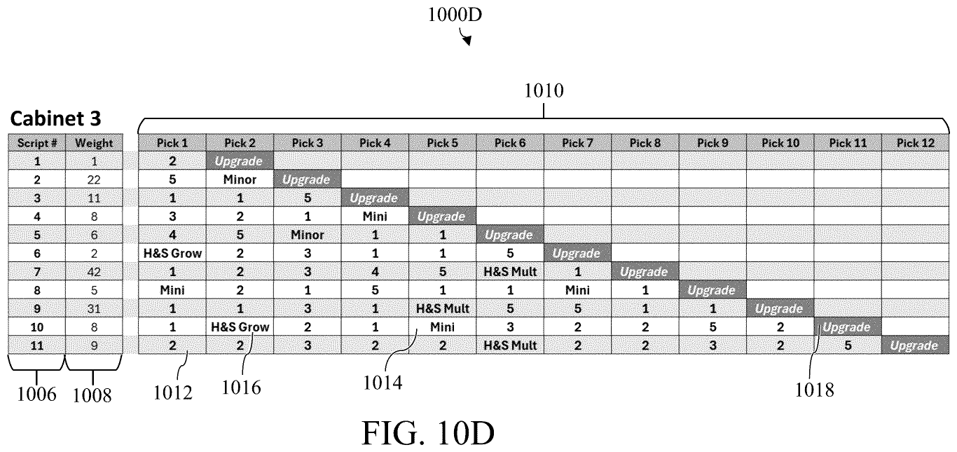

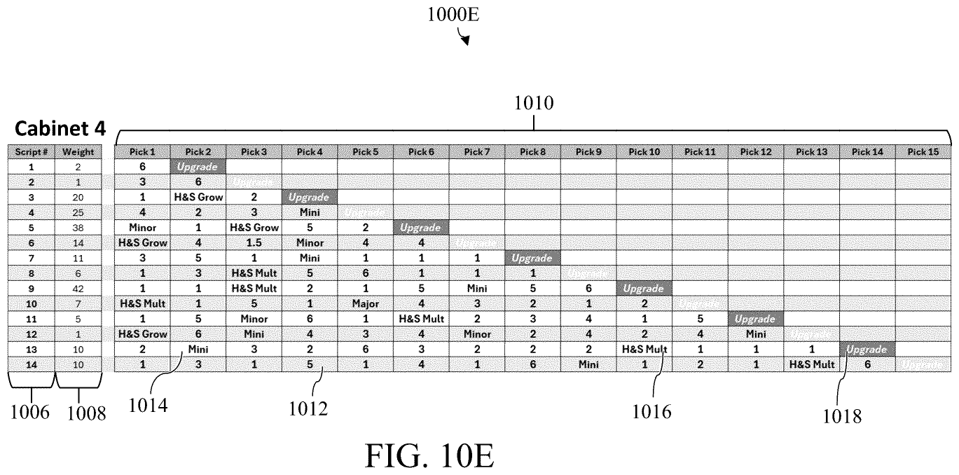

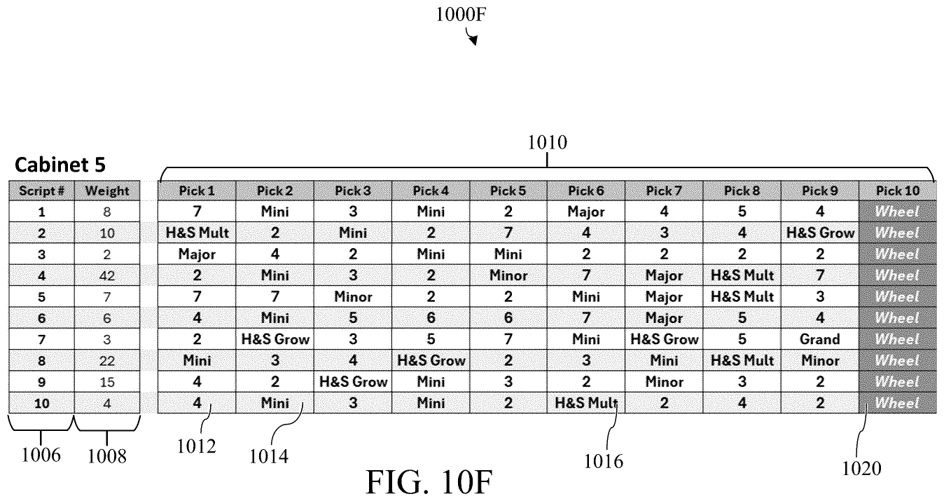

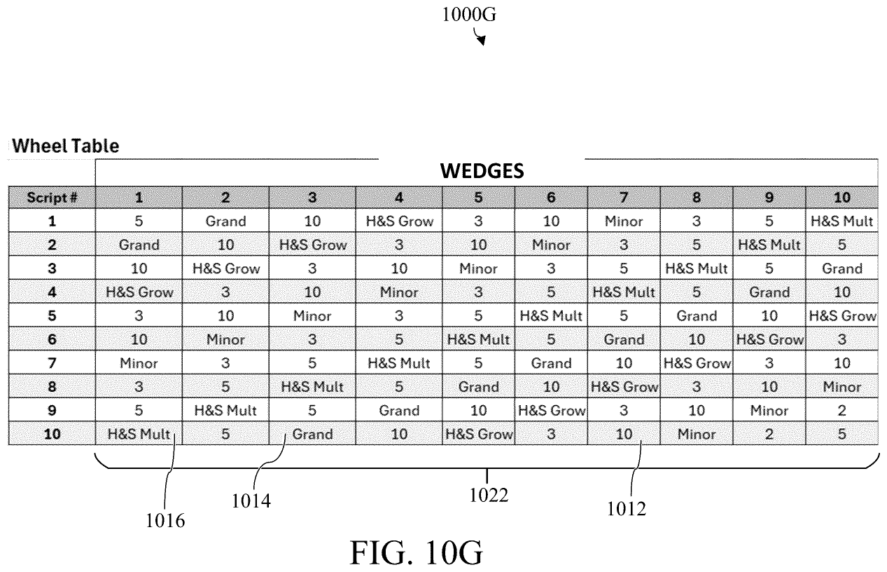

FIGS. 10A-10G are example tables displaying various gameplay scripts of interactive pick bonus game 500 (see e.g., FIGS. 6A-7L) and the bonus wheel game 700 (see e.g., FIGS. 8A-8G). More specifically, FIG. 10A illustrates an example table displaying a number of cabinets and a corresponding number of bottles displayed in each cabinet for interactive pick bonus game 500, FIGS. 10B-10F show examples of various game scripted outcomes and/or outcome scenarios for a player of interactive pick bonus game 500, and FIG. 10G shows various examples of the plurality of wedges 776 included on bonus wheel 774 during bonus wheel game 700.

FIG. 10A illustrates an example table 1000A displaying a number of cabinets 1002 that are included within interactive pick bonus game 500 and a corresponding number of bottles 1004 displayed in each cabinet for interactive pick bonus game 500. In the exemplary embodiment, interactive pick bonus game 500 includes five (5) distinct cabinets 1002. As similarly discussed herein with respect to FIGS. 4A and 6A-6H, each of the five (5) cabinets 1002 displayed in table 1000A correspond to a respective emblem 548A-548E and corresponding graphical icon 436 (“cabinet”) depicted on display device 412 during interactive pick bonus game 500. Additionally, the number of bottles 1004 depicted in table 1000A also correspond to each group of pick bonus game symbols 438A-438E relating to respective emblems 548A-548E. For example, the first cabinet (e.g., “1”) included in table 1000A, which corresponds to first emblem 548A (see, FIG. 4A) includes seven (7) bottles 1004 corresponding to the first group of pick bonus game symbols 438A (see, FIG. 4C). As discussed herein, any number cabinets and/or any number of bottles can be included in the gameplay of interactive pick bonus game 500.

FIGS. 10B-10E illustrates example game scripted outcomes and/or outcome scenarios for interactive pick bonus game 500. More specifically, FIGS. 10B-10E include tables 1000B-1000E depicting numerous scripted outcomes or outcome scenarios 1006 (hereafter, “scripted outcomes 1006”) for each cabinet played during interactive pick bonus game 500, a weighted factor 1008 determining the likelihood in which the specific scripted outcome 1006 occurs during interactive pick bonus game 500, as well as pick results 1010 for each scripted outcome 1006. Pick results 1010 can include predetermined credit values 1012 designated by numbers (e.g., 1, 2, 3, etc.), jackpot credit values 1014, hold-and-spin indicators 1016, and upgrade indicators 1018. In exemplary embodiments scripted outcome 1006 is predetermined and/or randomly selected for each cabinet in which a player interacts with at the start of base reel game 400. Alternatively, scripted outcome 1006 is predetermined and/or randomly selected for the first cabinet (e.g., emblem 548A) at the start of base reel game 400, and each subsequent scripted outcome 1006 associated with each subsequent cabinet (e.g., emblems 548B-548E) is randomly selected upon the player upgrading the cabinets and/or selecting upgrade feature 556 from distinct groups of pick bonus game symbols 438 (see, FIGS. 7B-7E). For example, and as shown in FIG. 10B, “Script 4” for cabinet 1 ensures the player will make five (5) selections or picks before upgrading to cabinet 2 (see, FIG. 10C). Specifically, the first three picks of script 4 within cabinet 1, as shown in table 1000B, will result in the player receiving three distinct credit values 1012. Additionally, the fourth pick of script 4 for cabinet 1 includes hold-and-spin indicators 1016 (e.g., hold-and-spin bonus game feature 560; FIG. 7K) which will trigger hold-and-spin bonus game 600 (see, FIGS. 7K and 7L). Finally, at the fifth pick of script 4 for cabinet 1, as shown in table 1000B, upgrade indicators 1018 is selected (e.g., upgrade feature 556; FIG. 7B) which will in turn enable cabinet 2 for interactive pick bonus game 500 (see, FIGS. 7B-7E).

Although each table 1000B-1000E includes a corresponding number of scripted outcomes 1006, it is understood that each cabinet can include more or less scripted outcomes 1006. That is, depending upon, at least in part, predetermined scripted outcomes 1006, the number of bottles 1004 included in each cabinet 1002 (see, FIG. 10A), and/or the credit values/features included in each scripted outcome 1006, each cabinet depicted in tables 1000B-1000E can include more or less scripted outcomes 1006. Additionally, and after each successive gameplay, the pick results 1010 for each scripted outcome 1006 can change and/or be randomized.

FIG. 10F depicts scripted outcomes 1006 for cabinet 5 played during interactive pick bonus game 500. Specifically, table 1000F corresponding to cabinet 5 of interactive pick bonus game 500 corresponds to emblem 548E and/or the final cabinet included within interactive pick bonus game 500. As similarly discussed herein, table 1000F includes scripted outcomes 1006, weighted factor 1008 determining the likelihood in which the specific scripted outcome 1006 occurs during interactive pick bonus game 500, as well as pick results 1010 for each scripted outcome 1006. Distinct from tables 1000B-1000E, each scripted outcome 1006 included in table 1000F includes ten (10) picks, where the tenth pick includes the bonus wheel indicator 1020, which triggers bonus wheel game 700 including bonus wheel 774 (see, FIGS. 8A-8G). Although each scripted outcome 1006 includes ten picks to trigger bonus wheel game 700, via bonus wheel indicator 1020, the combination of the plurality of preceding picks are distinct for each scripted outcome 1006.

Table 1000G of FIG. 10G shows the values and/or features included in bonus wheel 774 for each scripted outcome 1006 of cabinet 5 (see, table 1000F; FIG. 10F), when bonus wheel indicator 1020 is selected and bonus wheel game 700 is triggered during interactive pick bonus game 500. For example, each of the ten (10) wedge values 1022 of table 1000G represent and/or correspond to either the credit value feature 778, jackpot feature 780, or hold-and-spin feature 782 included on each of plurality of wedges 776 of bonus wheel 774 for bonus wheel game 700. In the exemplary embodiment where cabinet 5 includes 20 bottles 1004 (see, FIG. 10A), and ten picks are made to select upgrade indicators 1018 and/or trigger bonus wheel game 700, ten (10) bottles or symbols (e.g., pick bonus game symbols 438) remain unselected. As such, and as similarly discussed herein with respect to FIGS. 8C-8F, wheel 774 for bonus wheel game 700 includes ten (10) wedges 776, as indicated in table 1000G.

As discussed herein, bonus wheel 774 of bonus wheel game 700 can include any number of wedges 776. For example, where cabinet 5 includes twenty (20) bottles 1004, as indicated in table 1000A of FIG. 10A, bonus wheel 774 can include between one (1) and nineteen (19) wedges 776. The number of wedges 776 included within bonus wheel 774 during bonus wheel game 700 can be determined by a plurality of various tables and/or scripted outcomes 1006 for cabinet 5, as similarly shown and discussed herein with respect to FIGS. 10F and 10G. As such, it should be understood that tables 1000A-1000G shown herein are exemplary tables and depict exemplary scripted outcomes 1006 for each cabinet of interactive pick bonus game 500.

A computer, controller, or server, such as those described herein, includes at least one processor or processing unit and a system memory. The computer, controller, or server typically has at least some form of computer readable non-transitory media. As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit, and other programmable circuits “configured to” carry out programmable instructions, and these terms are used interchangeably herein. In the implementations described herein, memory may include, but is not limited to, a computer-readable medium or computer storage media, volatile and nonvolatile media, removable and non-removable media implemented in any method or technology for storage of information such as computer readable instructions, data structures, program modules, or other data. Such memory includes a random access memory (RAM), computer storage media, communication media, and a computer-readable non-volatile medium, such as flash memory. Alternatively, a floppy disk, a compact disc - read only memory (CD-ROM), a magneto-optical disk (MOD), and/or a digital versatile disc (DVD) may also be used. Also, in the implementations described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary implementation, additional output channels may include, but not be limited to, an operator interface monitor.

As indicated above, the process may be embodied in computer software. The computer software could be supplied in a number of ways, for example on a tangible, non-transitory, computer readable storage medium, such as on any nonvolatile memory device (e.g. an EEPROM). Further, different parts of the computer software can be executed by different devices, such as, for example, in a client-server relationship. Persons skilled in the art will appreciate that computer software provides a series of instructions executable by the processor.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. An electronic gaming system comprising:
at least one memory for storing instructions; and
a game controller in communication with the at least one memory, the game controller including at least one processor, wherein when the instructions are executed by the at least one processor, the at least one processor is configured to:
cause to be displayed on a touch enabled display device a base reel game including a plurality of reels;
determine that a first outcome of the base reel game triggers an interactive pick bonus game;
cause to be displayed on the touch enabled display device a first group of pick bonus game symbols, each of the pick bonus game symbols associated with a credit value or an action feature;
in response to at least one pick bonus game symbol of the first group of pick bonus game symbols being selected via the touch enabled display device, cause to be displayed on the touch enabled display device the credit value or the action feature associated with the at least one selected pick bonus game symbol of the first group;
cause to be re-displayed on the touch enabled display device the base reel game; and
in response to determining that a subsequent outcome of the re-displayed base reel game triggers the interactive pick bonus game, cause to be re-displayed on the touch enabled display the interactive pick bonus game, the re-displayed interactive pick bonus game persisting to display the credit value or the bonus feature associated with the at least one selected pick bonus game symbol for the first group.

2. The electronic gaming system of claim 1, wherein the action feature further includes:
a free pick feature for adding an additional pick to the interactive pick bonus game;
an upgrade feature for transforming the first group of pick bonus game symbols to a second group of pick bonus game symbols, at least one of the pick bonus game symbols of the second group being distinct from the pick bonus game symbols of the first group;
a jackpot feature for awarding a jackpot credit value defined in the base reel game;
a hold-and-spin game feature for triggering a hold-and-spin bonus game; and
a wheel spin feature for triggering a bonus wheel game.

3. The electronic gaming system of claim 2, wherein the instructions stored in the memory, when executed by the at least one processor, further cause the at least one processor to:
in response to determining the at least one selected pick bonus game symbol includes the upgrade feature, cause to be displayed on the touch enabled display device the second group of pick bonus game symbols during the interactive pick bonus game.

4. The electronic gaming system of claim 3, wherein the instructions stored in the memory, when executed by the at least one processor, further cause the at least one processor to:
in response to determining the at least one selected pick bonus game symbol includes the upgrade feature, increase the number of picks for the interactive pick bonus game including the second group of pick bonus game symbols by a predetermined number of picks.

5. The electronic gaming system of claim 2, wherein the instructions stored in the memory, when executed by the at least one processor, further cause the at least one processor to:
in response to determining the at least one selected pick bonus game symbol includes the wheel spin feature, cause to be displayed on the touch enabled display device a bonus wheel of the bonus wheel game including a plurality of wedges,
wherein each of the plurality of wedges includes the credit value or the action feature associated with each unselected pick bonus game symbol for one of:
the first group of pick bonus game symbols, or
the second group of pick bonus game symbols.

6. The electronic gaming system of claim 5, wherein the instructions stored in the memory, when executed by the at least one processor, further cause the at least one processor to:
in response to determining a bonus wheel game outcome for the bonus wheel game, cause to be displayed on the display device a distinct pick bonus game, the distinct pick bonus game including a plurality of distinct pick game symbols,
wherein each of the plurality of distinct pick game symbols are associated one of:
the first group of pick bonus game symbols;
the second group of pick bonus game symbols, or
a third group of pick bonus game symbols, at least one of the pick bonus game symbols of the third group being distinct from the pick bonus game symbols of the first group and the second group; and
in response to one of the plurality of distinct pick game symbols being selected via the touch enabled display device during the distinct pick bonus game, cause to be displayed on the touch enabled display device one of: (i) the first group of pick bonus game symbols, (ii) the second group of pick bonus game symbols, or (iii) the third group of pick bonus game symbols during a subsequent displaying of the interactive pick bonus game.

7. The electronic gaming system of claim 1, wherein the instructions stored in the memory, when executed by the at least one processor, further cause the at least one processor to:
cause to be displayed on the touch enabled display device a graphical icon associated with the first group of pick bonus game symbols;
detect a user's touch on the touch enabled display device to select the graphical icon; and
cause to be displayed on the touch enabled display device the first group of pick bonus game symbols.

8. A method of electronic gaming implemented on an electronic gaming machine, the method comprising:
causing to be displayed on a touch enabled display device a base reel game including a plurality of reels;
determining that a first outcome of the base reel game triggers an interactive pick bonus game;
causing to be displayed on the touch enabled display device a first group of pick bonus game symbols, each of the pick bonus game symbols associated with a credit value or an action feature;
in response to at least one pick bonus game symbol of the first group of pick bonus game symbols being selected via the touch enabled display device, causing to be displayed on the touch enabled display device the credit value or the action feature associated with the at least one selected pick bonus game symbol of the first group;
causing to be re-displayed on the touch enabled display device the base reel game; and
in response to determining that a subsequent outcome of the re-displayed base reel game triggers the interactive pick bonus game, causing to be re-displayed on the touch enabled display the interactive pick bonus game, the re-displayed interactive pick bonus game persisting to display the credit value or the bonus feature associated with the at least one selected pick bonus game symbol for the first group.

9. The method of claim 8, wherein the action feature further includes:
a free pick feature for adding an additional pick to the interactive pick bonus game;
an upgrade feature for transforming the first group of pick bonus game symbols to a second group of pick bonus game symbols, at least one of the pick bonus game symbols of the second group being distinct from the pick bonus game symbols of the first group;
a jackpot feature for awarding a jackpot credit value defined in the base reel game;
a hold-and-spin game feature for triggering a hold-and-spin bonus game; and
a wheel spin feature for triggering a bonus wheel game.

10. The method of claim 9, further comprising:
in response to determining the at least one selected pick bonus game symbol includes the upgrade feature, causing to be displayed on the touch enabled display device the second group of pick bonus game symbols during the interactive pick bonus game.

11. The method of claim 10, further comprising:
in response to determining the at least one selected pick bonus game symbol includes the upgrade feature, increase the number of picks for the interactive pick bonus game including the second group of pick bonus game symbols by a predetermined number of picks.

12. The method of claim 9, further comprising:
in response to determining the at least one selected pick bonus game symbol includes the wheel spin feature, causing to be displayed on the touch enabled display device a bonus wheel of the bonus wheel game including a plurality of wedges,
wherein each of the plurality of wedges includes the credit value or the action feature associated with each unselected pick bonus game symbol for one of:
the first group of pick bonus game symbols, or
the second group of pick bonus game symbols.

13. The method of claim 12, further comprising:
in response to determining a bonus wheel game outcome for the bonus wheel game, causing to be displayed on the display device a distinct pick bonus game, the distinct pick bonus game including a plurality of distinct pick game symbols,
wherein each of the plurality of distinct pick game symbols are associated one of:
the first group of pick bonus game symbols;
the second group of pick bonus game symbols, or
a third group of pick bonus game symbols, at least one of the pick bonus game symbols of the third group being distinct from the pick bonus game symbols of the first group and the second group; and
in response to one of the plurality of distinct pick game symbols being selected via the touch enabled display device during the distinct pick bonus game, causing to be displayed on the touch enabled display device one of: (i) the first group of pick bonus game symbols, (ii) the second group of pick bonus game symbols, or (iii) the third group of pick bonus game symbols during a subsequent displaying of the interactive pick bonus game.

14. The method of claim 8, further comprising:
causing to be displayed on the touch enabled display device a graphical icon associated with the first group of pick bonus game symbols;
detecting a user's touch on the touch enabled display device to select the graphical icon; and
causing to be displayed on the touch enabled display device the first group of pick bonus game symbols.

15. A non-transitory computer-readable storage medium with instructions stored thereon that, in response to execution by at least one processor, cause the at least one processor to:
cause to be displayed on a touch enabled display device a base reel game including a plurality of reels;
determine that a first outcome of the base reel game triggers an interactive pick bonus game;
cause to be displayed on the touch enabled display device a first group of pick bonus game symbols, each of the pick bonus game symbols associated with a credit value or an action feature;
in response to at least one pick bonus game symbol of the first group of pick bonus game symbols being selected via the touch enabled display device, cause to be displayed on the touch enabled display device the credit value or the action feature associated with the at least one selected pick bonus game symbol of the first group;
cause to be re-displayed on the touch enabled display device the base reel game; and
in response to determining that a subsequent outcome of the re-displayed base reel game triggers the interactive pick bonus game, cause to be re-displayed on the touch enabled display the interactive pick bonus game, the re-displayed interactive pick bonus game persisting to display the credit value or the bonus feature associated with the at least one selected pick bonus game symbol for the first group.

16. The non-transitory computer-readable storage medium of claim 15, wherein the action feature further includes:
a free pick feature for adding an additional pick to the interactive pick bonus game;
an upgrade feature for transforming the first group of pick bonus game symbols to a second group of pick bonus game symbols, at least one of the pick bonus game symbols of the second group being distinct from the pick bonus game symbols of the first group;
a jackpot feature for awarding a jackpot credit value defined in the base reel game;
a hold-and-spin game feature for triggering a hold-and-spin bonus game; and
a wheel spin feature for triggering a bonus wheel game.

17. The non-transitory computer-readable storage medium of claim 16, wherein the instructions, when executed, cause the at least one processor to:
in response to determining the at least one selected pick bonus game symbol includes the upgrade feature, cause to be displayed on the touch enabled display device the second group of pick bonus game symbols during the interactive pick bonus game.

18. The non-transitory computer-readable storage medium of claim 17, wherein the instructions, when executed, cause the at least one processor to:
in response to determining the at least one selected pick bonus game symbol includes the upgrade feature, increase the number of picks for the interactive pick bonus game including the second group of pick bonus game symbols by a predetermined number of picks.

19. The non-transitory computer-readable storage medium of claim 16, wherein the instructions, when executed, cause the at least one processor to:
in response to determining the at least one selected pick bonus game symbol includes the wheel spin feature, cause to be displayed on the touch enabled display device a bonus wheel of the bonus wheel game including a plurality of wedges,
wherein each of the plurality of wedges includes the credit value or the action feature associated with each unselected pick bonus game symbol for one of:
the first group of pick bonus game symbols, or
the second group of pick bonus game symbols.

20. The non-transitory computer-readable storage medium of claim 15, wherein the instructions, when executed, cause the at least one processor to:
cause to be displayed on the touch enabled display device a graphical icon associated with the first group of pick bonus game symbols;
detect a user's touch on the touch enabled display device to select the graphical icon; and
cause to be displayed on the touch enabled display device the first group of pick bonus game symbols.
